(19) United States
(12) Patent Application Publication
(10) Pub. No.: US 2006/0292039 A1
(43) Pub. Date: Dec. 28, 2006

(54) Measuring system

(76) Inventor: Kazuhiro Iida, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/570,312

(22) PCT Filed: Sep. 6, 2004
(86) PCT No.: PCT/JP04/12958

§ 371 Date: Mar. 2, 2006

(30) Foreign Application Priority Data
Sep. 5, 2003 (JP) 2003-314341

(51) Int. Cl. G01N 21/00

(52) U.S. Cl. 422/82.05

(57) ABSTRACT

It becomes possible for a user to check his/her own health state at a desired place without visiting inspection agencies. Furthermore, it becomes possible for a user to conveniently check his/her own health state. First, a user collects body fluid to be a measurement object, such as blood, saliva, and urine. Then, the collected body fluid is introduced to the chip (101) as a sample. Then, the sample is made to act on a detection reagent which acts on a specific component in the sample to generate a predetermined detection reaction. This chip (101) is set to the mobile terminal (127). A measurement unit (151) of the mobile terminal (127) measures an amount of a specific component in the sample by means that product of reaction is quantitated by an optical method or the like. The mobile terminal (127) transmits the measurement value to an analysis center (153).

### TECHNICAL FIELD

The present invention relates to a measurement system.

### BACKGROUND ART

In recent years, there has been a lot of interest in health management based on data. Furthermore, there are those who need to continuously obtain their biological data and check their health states. Conventionally, when such persons visit inspection agencies and undergo inspection, there are constraints in time and cost and therefore the busier persons are, the less opportunity they undergo inspection. Consequently, development of technology capable of readily checking of one's own health state without visiting inspection agencies has been required.

Consequently, a health management support system which automatically collects biological data at a health management center in a remote place is proposed (Patent Document 1). According to a technology described in the aforementioned document, a person to be inspected provides an exclusive terminal at home and thereby can transfer measurement results measured by a clinical thermometer or sphygmomanometer to medical agencies or the like. However, such a system has been relatively large scale device configuration. Furthermore, in the case where a person is out, measurement cannot be performed. Further, application to blood test or the like has been difficult. [Patent Document 1] Japanese Laid-open patent publication NO. 2003-76791

### DISCLOSURE OF THE INVENTION

In view of the foregoing, an object of the present invention is to provide a technology capable of checking one's own health state at a desired place even if a user does not visit inspection agencies. Another object of the present invention is to provide a technology that a user can readily check his/her own health state.

The following is indispensable to enable checking a health at a desired place:
(1) a measurement system has a portable mobile terminal;
(2) a measurement system can be used safely and healthfully;
(3) a mobile terminal has a communication function and a user can receive remote support via the mobile terminal.

Since a heavy and large device cannot be brought out to a desired place, a measurement system needs to be as small and light as possible. Automatically implementing analysis and measuring by using a light and small measuring chip is significantly advantageous for weight saving of a mobile terminal to.

Furthermore, safely and healthfully taking along a measuring chip and a mobile terminal is necessary for checking health at a desired place. In order to measure a biological sample with infectious risk at a health check, it is effective that a portion for introducing a biological sample and a measuring device are separated, for example, a biological sample is introduced to only a measuring chip, a measuring device is provided in a mobile terminal which does not come in contact with the biological sample, and a measuring chip is used once and then thrown away. Further, there is a case where a mechanism for neutralizing a measuring chip needs to be provided because it becomes unsuitable for a mobile sanitarily when disinfectant treatment is not certainly applied to a measuring chip, depending on kinds of samples and measurements.

Furthermore, in the case where a health check is performed except at a place with well support system such as a medical center, a user needs to interact with an expert at a remote place and database in order to understand what the measurement value means in health, to know whether or not the measurement results are correct, and to further restore false operation of a measurement system. Therefore, it is significantly important that a mobile terminal has communication function and is incorporated in a user support system by means of communication.

According to the present invention, there is provided a measurement system including: a measuring chip which includes a sample introducing unit and a detection unit communicated to the sample introducing unit, the chip applying a predetermined operation to a sample introduced into the sample introducing unit and introducing it to the detection unit; and a mobile terminal which performs measurement on a specific component contained in the sample introduced to the measuring chip, wherein the mobile terminal includes an insertion portion in which the measuring chip is inserted, a measurement unit which performs measurement on characteristics of the component introduced to the detection unit, and a transmitting unit which transmits measurement result obtained by the measurement unit outside.

The measurement system of the present invention includes the mobile terminal which has the insertion portion of the measuring chip and the measurement unit. Therefore, a user of the measurement system inserts the measuring chip to the mobile terminal and can perform measurement on the specific component in the sample at a desired time and a desired place. Consequently, measurement can be readily performed on the spot using the measurement system of simple device configuration without installing a large measuring device at home and visiting inspection agencies.

Furthermore, in the measurement system of the present invention, measurement is performed by inserting a predetermined part of the measuring chip to the insertion portion of the mobile terminal. That is, different function can be given to two members of the measuring chip which performs a predetermined processing to the sample and the mobile terminal which performs measurement of the sample on the measuring chip. Consequently, measurement can be performed without directly attaching the sample to the mobile terminal.

Further, since the mobile terminal which constitutes the measurement system and the measuring chip each can be separately designed, various sorts of effects may be obtained. That is, a plurality of measuring chips can be selected according to kinds of the measurement. Furthermore, the measuring chip may be disposable mode. On the contrary, in the case where the mobile terminal is used in the measurement, configuration of the measurement unit is required to be a small and simple mode from the request of reduction in size and weight for which the mobile terminal is required. On the other hand, when the sample is a biological sample or the like, there is a case that correct measurement result cannot be obtained if a collected sample is directly measured. The measurement system of the present invention adopts configuration that the mobile terminal and the measuring chip are separated, whereby the measurement unit of the mobile terminal has minimum simple configuration and the measuring chip has configuration capable of performing a predetermined processing necessary for the measurement. That is, the sample introduced to the measuring chip is applied by the predetermined operation and is introduced to the detection unit, whereby multiple processing may be performed to the sample of premeasurement. Therefore, the sample introduced to the measuring chip can be introduced to the detection unit in a state suitable for the measurement. Consequently, simplification and reduction in size and weight of device configuration of the mobile terminal can be made and accurate measurement result on the component in the sample can be obtained.

Still, in the measurement system according to the present invention, since the mobile terminal has the transmitting unit, measurement result can be readily transmitted outside and analysis result based on the measurement result can be obtained from outside. Therefore, the mobile terminal itself does not need to provide analysis function. Consequently, device configuration of the mobile terminal can be simplified and accurate analysis result based on the measurement result can be obtained.

In the present invention, the “measuring chip” denotes a substrate in which function for applying the predetermined operation to the introduced sample is given. The chip in the present invention may be configured, for example, so that a channel groove is provided in the substrate surface and liquid sample flows in the channel groove to develop a predetermined reaction such as chromogenic reaction depending on concentration of a specific component. The liquid sample may move in the channel groove using capillary phenomenon or the like and may move by being applied with external force such as electric field or pressure.

In the measurement system of the present invention, the predetermined operation may be, for example, dispensation of the aforementioned sample. In doing so, it becomes possible to introduce the sample of quantity suitable for measurement by the measurement unit to the detection unit. Furthermore, in the measurement system of the present invention, the predetermined operation may be dilution of the sample. The sample introduced to the measuring chip may be introduced to the detection unit at concentration further suitable for measurement by diluting the sample. Consequently, it is possible to obtain further accurate measurement result.

According to the present invention, there is provided a measurement system including: a measuring chip which includes a sample introducing unit and a detection unit communicated to the sample introducing unit, the chip applying a predetermined operation to a sample introduced to the sample introducing unit and introducing it to the detection unit; and a mobile terminal which performs measurement on a specific component contained in the sample introduced to the measuring chip, wherein the mobile terminal includes a measurement unit which performs measurement on characteristics of the component introduced to the detection unit, and a transmitting unit which transmits measurement result obtained by the measurement unit outside.

In such measurement system, the measuring chip and the mobile terminal each can be separately designed. Furthermore, according to the measurement system of the present invention, contact type or non-contact type measurement can be performed without inserting the chip into the mobile terminal. Further, it becomes possible that an adapter is connected to the measuring device and measurement of the sample introduced to the detection unit via the adapter is performed. Contamination of the mobile terminal generated by adherence of the sample to the mobile terminal may be further certainly suppressed by measuring via the adapter. Still, configuration of the chip applicable to measurement by the mobile terminal may be further diversified by using the adapter.

In the measurement system of the present invention, the measurement unit may include a light source which irradiates light to the detection unit, and a light receiving unit which performs measurement on optical characteristics of the component using outgoing light from the light source. In doing so, the optical characteristics of the component in the sample introduced to the measuring chip may be certainly measured. Therefore, in the mobile terminal, necessary minimum measurement data on the specific component in the sample may be obtained by a simple configuration. Then, detail analysis result may be obtained by transmitting the measurement result outside. Consequently, it becomes possible to simplify device configuration of the mobile terminal and perform detail analysis.

In the measurement system of the present invention, the measuring chip may include a channel which reaches the detection unit from the sample introducing unit, and a separating unit which separates the component is provided in the channel. In doing so, the component in the sample introduced to the measuring chip may be certainly separated. Therefore, introducing to the detection unit can be made after eliminating foreign substances in the sample. Consequently, since the sample preferable for measurement in the measurement unit may be prepared on the measuring chip, even if the component to be measurement object is minute amount, this may be separated to reduce background in measurement. Consequently, further accurate measurement may be performed.

In the measurement system of the present invention, the detection unit may provide a detecting substance which acts on the component and changes optical characteristics thereof. In doing so, the component in the sample introduced to the measuring chip may be certainly obtained. Consequently, high sensitive measurement even to the minute amount component may be performed.

In the measurement system of the present invention, the transmitting unit may transmit the measurement result correlating with a measurement state outside. In doing so, the measurement result may be subjected to external analysis correlating with the measurement state. Furthermore, it becomes possible to correct the measurement result according to the measurement state at the outside where the measurement result is received. In addition, in the present invention, the measurement state may be, for example, measurement time and date, measurement place, or the like.

In the measurement system of the present invention, the mobile terminal may be configured to have mobile phone function. In doing so, a user of the measurement system may measure on the spot at a desired time by carrying only the mobile phone and the measuring chip. Furthermore, the entire measurement system may be reduced in size by setting the mobile terminal as a mobile terminal of a mobile phone or the like.

The measurement system of the present invention further includes an analysis center which is connected to the mobile terminal via a network and receives an information transmitted from the mobile terminal, the analysis center may include a data acquisition unit which obtains the measurement result transmitted from the mobile terminal, and an analysis unit which analyzes the sample based on measurement result obtained by the data acquisition unit and obtains analysis result.

Since the measurement system of the present invention includes the analysis center, device configuration of the mobile terminal is simplified, the measurement result by the mobile terminal is obtained by the data acquisition unit and analysis of the component in the sample introduced to the measuring chip may be certainly performed by the analysis unit.

In the measurement system of the present invention, the analysis center may include an analysis data memory unit which stores the measurement result or analysis result obtained by the analysis unit, and a reference data memory unit which stores data in which the analysis unit references.

It becomes possible to store the analysis result in the analysis center by having the analysis data memory unit. Furthermore, the reference data memory unit is included, whereby analysis at the analysis center may be certainly performed. Further, the reference data stored in the reference data memory unit may be corrected based on information stored in the analysis data memory unit.

Furthermore, in the measurement system of the present invention, the measuring chip may further include a neutralization reservoir, and the mobile terminal and the measuring chip further have a mechanism in which in which a removal of the measuring chip of post measurement from the mobile terminal is a trigger for introduction of the neutralization liquid in the neutralization reservoir into a channel system included in the measuring chip. In doing so, the channel system formed in the chip of post-use can be neutralized and therefore the measuring chip of post-use may be more safely carried.

In the measurement system of the present invention, the mobile terminal may include a receiving unit which receives the analysis result transmitted from the transmitting unit. In doing so, the analysis result based on the measurement result may be received from the mobile terminal. Consequently, a user of the measurement system may confirm the analysis result at a desired place.

In addition, in the present invention, the channel system denotes a moving pathway of liquid which reaches the sample introducing unit from the sample introducing unit provided in the measuring chip. For example, in the present invention, it may be configured that the neutralization liquid is introduced to the channel.

In the measurement system of the present invention, it may be made that the measuring chip further includes a unit which records authentication data, and the mobile terminal has a mechanism in which a removal of the measuring chip of post measurement from the mobile terminal or a completion of receiving data at the mobile terminal is a trigger for disabling of a read of the authentication data. In doing so, the chip of post-use may be further safely scrapped.

In the measurement system of the present invention, the sample may be body fluid. In doing so, it becomes possible that the measurement system readily performs measurement on body fluid of a user by simple configuration. Consequently, a user of the measurement system can perform measurement on his/her own health state at a desired time and at a desired place.

As described above, according to the present invention, a user can check his/her own health state at a desired place without visiting inspection agencies. Furthermore, according to the present invention, a user can simply check his/her own health state.

### BRIEF DESCRIPTION OF THE DRAWINGS

The aforementioned and other objects, features and advantages will become clear from the following description of the preferred embodiments and the attached drawings.

FIG. 1 is a view showing an inspection system according to an embodiment of the present invention;

FIG. 2 is a view explaining measurement procedure for use in the inspection device of FIG. 1;

FIG. 3 is a view showing configuration of a chip applicable for the inspection system of FIG. 1;

FIG. 4 is a view showing configuration of a mobile terminal applicable for the inspection system of FIG. 1;

FIG. 5 is a view showing a cross-section in a direction of the line C-C′ of FIG. 4;

FIG. 6 is a view showing a cross-section in the direction of the line C-C′ of FIG. 4;

FIG. 7 is a view showing a cross-section in the direction of the line C-C′ of FIG. 4;

FIG. 8 is a view showing a cross-section in the direction of the line C-C′ of FIG. 4;

FIG. 9 is a view showing configuration of the chip applicable for the inspection system of FIG. 1;

FIG. 10 is a cross-sectional view taken along the line D-D′ of FIG. 9;

FIG. 11 is a view showing a mobile terminal applicable for the inspection system of FIG. 1;

FIG. 12 is a view showing configuration of the inspection system of FIG. 1 for each functional block;

FIG. 13 is a view showing configuration of a chip having an electronic chip applicable for the inspection system according to an embodiment of the present invention;

FIG. 14 is a view showing an example of a data structure of an analysis result memory unit of the inspection system of FIG. 12;

FIG. 15 is a view showing an example of a data structure of a user information memory unit of the inspection system of FIG. 12;

FIG. 16 is a view showing an example of a data structure of an area information memory unit of the inspection system of FIG. 12;

FIG. 17 is a view for explaining processing procedure using the inspection system of FIG. 12;

FIG. 18 is a view showing configuration of a chip applicable for the inspection system of FIG. 1;

FIG. 19 is a view for explaining configuration of a separation region of the chip of FIG. 18;

FIG. 20 is a view for explaining a separation method using the configuration of the separation region of FIG. 19;

FIG. 21 is a view for explaining configuration of a mixing unit of the chip of FIG. 18;

FIG. 22 is a view for explaining the configuration of the mixing unit of the chip of FIG. 18;

FIG. 23 is an enlarged top view of a liquid switch of FIG. 22;

FIG. 24 is a top view of a damming unit of the liquid switch of FIG. 22;

FIG. 25 is a view for exemplifying configuration of a trigger channel of the liquid switch of FIG. 22;

FIG. 26 is a view of configuration of a chip applicable for the inspection system of FIG. 1;

FIG. 27 is a view for explaining configuration of a separation region of FIG. 26;

FIG. 28 is a view for explaining configuration of the separation region of the chip of FIG. 26;

FIG. 29 is a view showing configuration of an inspection system according to an embodiment of the present invention;

FIG. 30 is a view showing configuration of an inspection system according to an embodiment of the present invention;

FIG. 31 is a view showing configuration of a chip having an electronic chip applicable for the inspection system according to an embodiment of the present invention;

FIG. 32 is a view for explaining configuration of a separation region of the chip of FIG. 18;

FIG. 33 is a view for explaining configuration of the separation region of the chip of FIG. 18;

FIG. 34 is a view showing configuration of a mobile terminal with a detachable sensor according to an embodiment of the present invention;

FIG. 35 is a view showing configuration of a detachable optical sensor according to an embodiment of the present invention;

FIG. 36 is a view showing an example of configuration of a mobile terminal having a cleaning mechanism according to an embodiment of the present invention;

FIG. 37 is a cross-sectional view taken along the line F-F′ showing configuration adjacent to an end portion of the mobile terminal shown in FIG. 36;

FIG. 38 is a view showing configuration of a mobile terminal which generates a nullifying trigger according to an embodiment of the present invention;

FIG. 39 is a view showing timing in which the nullifying trigger according to the embodiment of the present invention generates in a mobile terminal;

FIG. 40 is a view showing configuration of a chip applicable for an inspection system according to an embodiment of the present invention;

FIG. 41 is a perspective view showing configuration of a measuring device applicable for an inspection system according to an embodiment of the present invention;

FIG. 42 is a perspective view showing configuration of the measuring device applicable for the inspection system according to the embodiment of the present invention;

FIG. 43 is a cross-sectional view showing configuration of a measuring device applicable for an inspection system of the present invention;

FIG. 44 is a cross-sectional view showing configuration of a mobile terminal applicable for an inspection system of the present invention; and

FIG. 45 is configuration showing configuration of a measuring device of an inspection system of the present invention.

### BEST MODE FOR CARRYING OUT THE INVENTION

Embodiments of the present invention will be described below with reference of the drawings. Note that in all the drawings, the same reference numerals are given to common constituent elements and their description will not be arbitrarily repeated.

(First Embodiment)

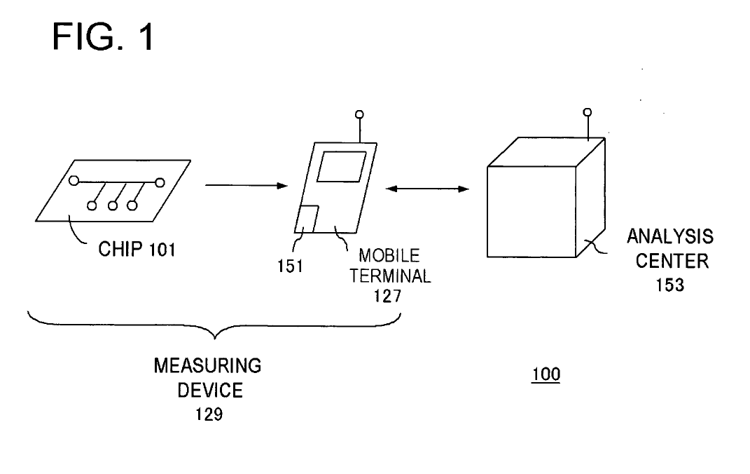

FIG. 1 is a view showing an inspection system of an embodiment. An inspection system 100 includes a measuring device 129 and an analysis center 153. The measuring device 129 is composed of a chip 101 and a mobile terminal 127 and each component has different function. The inspection system 100 performs measurement on a subject in user's body fluid using the measuring device 129 to examine user's health state.

The mobile terminal 127 may be a mobile phone having communication function, a personal digital assistant (referred to as PDA), or the like. The case where the mobile terminal 127 is a mobile phone will be described below as an example. The mobile terminal 127 includes a measurement unit 151 which measures detection reaction at the chip 101. Here, the measurement unit 151 is, for example, a spectrophotometer, fluorophotometer, charge coupled device (referred to as CCD) camera, or the like. Furthermore, the mobile terminal 127 is configured so that judged result transmitted from an analysis center 153 can be presented to a user.

Further, an introduced sample is applied by a predetermined operation at the chip 101 and then introduced to a detection unit to undergo measurement at the measurement unit 151 of the mobile terminal 127. As for operation to the sample, for example, dispensation, dilution, pretreatment, separation, mixing, reaction, or the like may be included. The chip 101 is configured so that a user can introduce a sample thereinto and so as to dispense a quantity suitable for measurement at the measurement unit 151.

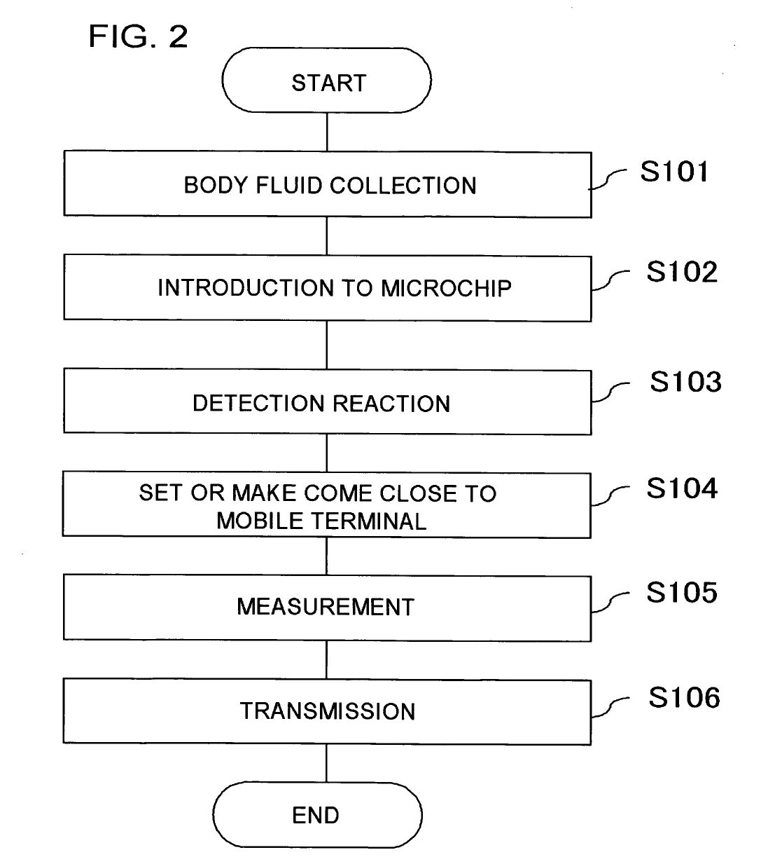

A user of the mobile terminal 127 dispenses body fluid such as his blood and urine to the chip 101. Then, this chip 101 is set to the mobile terminal 127 to obtain measurement value and its result is transmitted from the mobile terminal 127 to the analysis center 153. This procedure will be described with reference to FIG. 2.

FIG. 2 is a view for explaining a flow of analytic procedure using the chip 101. First, a user collects body fluid to be a measurement object, such as blood, saliva, and urine (S101). Then, the collected body fluid is introduced to the chip 101 as a sample (S102). Then, the sample is made to act on a detection reagent which acts on a specific component in the sample to generate a predetermined detection reaction (S103). This chip 101 is set to the mobile terminal 127 or is made to come close (S104). Optical measurement of the sample is performed at the measurement unit 151 of the mobile terminal 127 to detect a component specified from its characteristics (S105). The mobile terminal 127 transmits the measurement value to the analysis center 153 (S106). In this embodiment, the procedure from which a user collects his body fluid and instantaneously transmits the measurement value to the analysis center 153 is continuously performed at the same place and within a certain time.

In this way, it is possible in this embodiment that the chip 101 is set to the mobile terminal 127 or is made to come close to readily perform measurement. Furthermore, it is possible to instantaneously transmit the measurement result and ask the analysis center 153 for analysis.

In addition, measurement at the measurement unit 151 is measurement on optical property and electrical property of a component, for example. The case where the measurement unit 151 performs optical measurement will be described below as an example.

The analysis center 153 judges user's health state based on the measurement value transmitted from the user and reference parameters showing characteristics on the relevant measurement. Then, judged result is transmitted to the mobile terminal 127. Thereby, the user of the mobile terminal 127 can know user's own health state by a simple method without going to medical centers or inspection agencies.

Next, detail configuration of the chip 101 and the mobile terminal 127 will be explained.

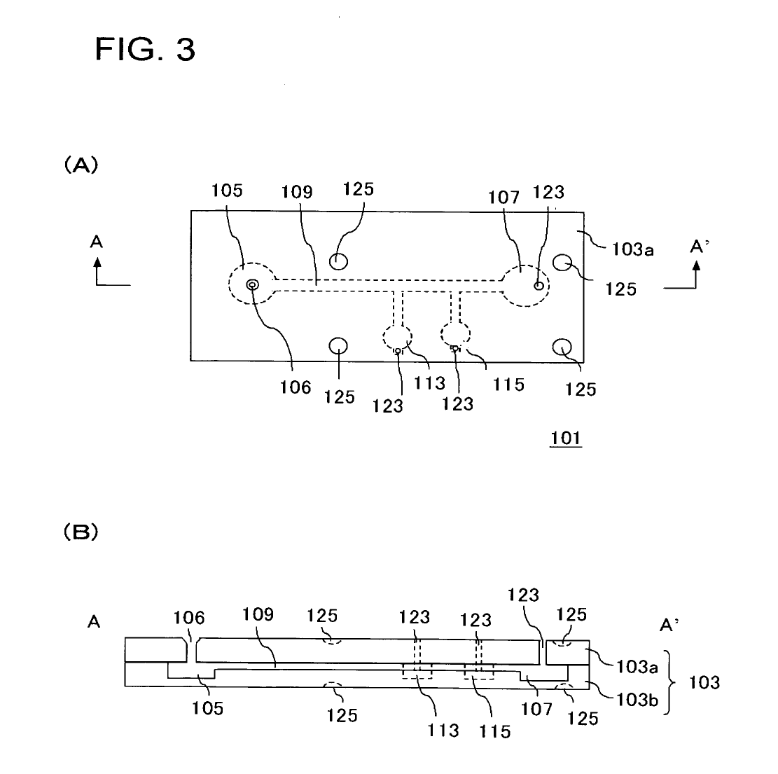

FIG. 3(A) and FIG. 3(B) are views showing an example of configuration of the chip 101. FIG. 3(A) is a top view of the chip 101. FIG. 3(B) is a cross-sectional view in the direction of the line A-A′ of FIG. 3(A).

The chip 101 is made up of a substrate 103 in which a substrate upper part 103a and a substrate lower part 103b are bonded. A sample introducing unit 105, a reservoir 107, a channel 109, a detection unit 113, and a detection unit 115 are formed on the substrate lower part 103b. The channel 109 communicates with the sample introducing unit 105, the reservoir 107, the detection unit 113, and the detection unit 115.

The substrate upper part 103a covers the channel 109 as a cover of the substrate lower part 103b. The reservoir 107, the detection unit 113, and an air hole 123 communicating with the detection unit 115 are formed on the substrate upper part 103a. Furthermore, an inlet 106 communicating with the sample introducing unit 105 is provided. The inlet 106 is configured so that a sample of a measurement object is smoothly introduced to the sample introducing unit 105 by capillary phenomenon. That is, of the sample introducing unit 105, a portion formed on the substrate upper portion 103a has narrowness with a width sufficient for realization of capillary effect, specifically not more than 1 mm, for example, and communicates with the reservoir portion formed in the substrate lower portion 103b. In addition, an upper portion of a capillary tube formed in the substrate upper portion 103a has a taper which is enlarged toward the upper surface so that a user can certainly introduce the sample.

Further, four concave portions 125 for being suitably inserted into the mobile terminal 127 are provided on the substrate upper portion 103a and the substrate lower portion 103b, respectively.

The chip 101 of FIG. 3(A) and FIG. 3(B) has two detection units, the detection unit 113 and detection unit 115, the number of the detection unit is not limited, but predetermined numbers may be set. These detection units can perform detection reaction for detecting predetermined components in the sample introduced to the sample introducing unit 105. A detecting substance, which acts on a component in a sample to make optical characteristics thereof change, can be provided in these detection units. For example, color former which colors depending on the presence of a characteristic component may be introduced in the detection unit 113 or the detection unit 115. In addition, of a plurality of detection units, it is also possible that color former is not introduced in one reservoir to use as a reference reservoir.

For example, a silicon substrate, a glass substrate such as quartz, resin substrates such as silicone resin and polymethylmethacrylate and a like can be used as the substrate upper portion 103a and the substrate lower portion 103b. Furthermore, outward dimensions of the chip 101 are suitably selected depending on mobile phone sizes and measurement objects, however, for example, longitudinal in the figure may be approximately 1 cm to 5 cm, transversal, approximately 1 cm to 5 cm. Furthermore, thickness of the chip 101 may be approximately 0.5 mm to 1 cm, for example.

The chip 101 of FIG. 3 is manufactured in the following way, for example. A groove is formed in the substrate lower portion 103b to be as the channel 109. Furthermore, the sample introducing unit 105, detection unit 113, and detection unit 115, all of which communicate with the channel 109, are formed. In the case where plastic material is used as the substrate lower portion 103b, these can be formed by known methods suitable for kinds of material of the substrate lower portion 103b, such as etching, press molding using metal molds such as emboss forming or the like, injection molding, formation by optical curing, and the like. Width of the channel 109 is suitably set according to separation purposes. For example, in cellular liquid fractionated components (cytoplasm), when extraction of high molecular weight components (DNA, RNA, protein, and sugar chain) is performed, the width is set to 5 μm to 1000 μm. The concave portion 125 is formed on the back side of the substrate lower portion 103b in a similar way. Furthermore, the inlet 106, the air hole 123, and the concave portion 125 are formed in the substrate upper portion 103a.

The chip 101 is obtained by bonding the thus obtained substrate upper portion 103a and substrate lower portion 103b.

In addition, in the case where the substrate upper portion 103a and the substrate lower portion 103b are made of plastic material, these can be bonded by heat seal, for example. In this case, in a state heated up to near the glass-transition temperature of the resin which constitutes the substrate upper portion 103a and the substrate lower portion 103b, both substrate portions are brought into contact with each other and pressure-bonding, after that, the temperature is made to decrease to the room temperature and then pressure is released.

Furthermore, fusion using solvent may be performed. In this case, it is possible that solvent, which makes the substrate upper portion 103a and the substrate lower portion 103b dissolve, is extremely thinly sprayed on these substrate surfaces and then these substrate portions are brought into contact with each other to bond.

Further, it may be performed that in a state where the substrate upper portion 103a and the substrate lower portion 103b are brought into contact with each other, ultrasonic vibration is applied to these substrate portions and the surfaces of the substrate upper portion 103a and the substrate lower portion 103b are melted by energy of the ultrasonic vibration to bond.

Still, it may be bonded by using adhesive agent selected depending on the kinds of the substrate upper portion 103a and the substrate lower portion 103b. In the case of using adhesive agent, imperceptible space such as the channel 109 or the like is required not to be embedded. Therefore, for example, adhesive agent may be extremely thinly coated or developed only on the substrate lower portion 103b. Furthermore, adhesive agent may be coated or developed only on a portion except the imperceptible structure of the substrate upper portion 103a using a mask to bond the substrate lower portion 103b.

Further, in the case where the substrate upper portion 103a and the substrate lower portion 103b are made of, for example, glass, quartz, or silicon substrate whose surface is oxidized, these substrate portions can be fused together with solvent, for example. Specifically, for example, hydrogen fluoride solution is extremely thinly sprayed on the surfaces of the substrate upper portion 103a or the substrate lower portion 103b and then these are heated to bond in a state where both substrate portions are pressed. In addition, adhesive agent such as SOG (silicon oxide gel) may be used. In the case of using SOG, SOG is coated or developed on the surfaces of the substrate upper portion 103a or the substrate lower portion 103b and then these are brought into contact with each other, and these substrate portions may be heated to approximately 200° C. in an oven. SOG can be vitrified by heating and consequently these substrate portions can be certainly bonded.

Furthermore, in the case where the substrate upper portion 103a and the substrate lower portion 103b are made of rubber, cross-linker can be used as adhesive agent. The adhesive agent is applied on the surfaces of the substrate upper portion 103a or the substrate lower portion 103b and these substrate portions are made to perform cross-linking reaction in a state where both substrates are pressed, thereby bonding these substrate portions.

In addition, in order to prevent a molecule such as DNA and protein from adhering to wall surfaces of the channel 109 or the like, it is preferable to apply coating on the wall surfaces. Thereby, the chip 101 can exhibit good separative performance. As for coating materials, for example, substances having a structure similar to phospholipid which constitutes a cell membrane may be included. Furthermore, the wall of the channel is coated by water-shedding resin such as fluorine system resin or hydrophile such as bovine serum albumin, whereby a molecule such as DNA can be prevented from adhering to the wall of the channel. Further hydrophilic macromolecule material such as MPC (2-methacryloyloxyethyl phosphorylcholine) polymer and hydrophilic silane coupling agent may be coated on the surface of the substrate lower portion 103b.

In the case where the surface of the substrate lower portion 103b is performed to become hydrophilic using MPC polymer, specifically, for example, LIPIDURE (registered trademark, manufactured by NOF CORPORATION) or the like may be used. In the case of using LIPIDURE (registered trademark), for example, this LIPIDURE is dissolved in buffer solution such as TBE (Tris-borate+EDTA) so as to be 0.5 wt %, this solution is filled in the channel 109, and this state is left for several minutes, thereby enabling the wall of the channel to be coated.

Furthermore, the surface of the substrate lower portion 103b including the wall of the channel become hydrophilic, thereby certainly enabling a sample to be introduced to the inlet 106 using capillary phenomenon. Further, the sample introduced to the inlet 106 is more certainly introduced to the channel 109, thereby enabling it to be moved in the channel 109 by capillary phenomenon. As a method in which the surface of the substrate lower portion 103b becomes hydrophilic, it is effective to form hydrophilic membrane such as silicon dioxide film and a like on the surface of the channel 109. The buffer solution is smoothly introduced by forming the hydrophilic membrane, without applying external force especially.

Furthermore, at least the surface of the substrate lower portion 103b is made up of hydrophilic macromolecule material such as PHEMA (polyhydroxyethyl methacrylate), thereby promoting capillary effect. Further, nonspecific adsorption of a sample component on the surface of the substrate lower portion 103b can be suppressed. Therefore, even the sample is extremely small in amount, separation and detection or measurement can be certainly performed. Further, the surface of the substrate lower portion 103b is made up of titanium oxide and the surface is treated with ultraviolet irradiation, whereby the surface of the substrate lower portion 103b can become hydrophilic. In addition, ashing may be performed on the surface of the substrate lower portion 103b with oxygen plasma.

As described above, predetermined components in the sample can be separated and further detected by using the chip 101 according to this embodiment. Thus, for example, in the case where color reaction is performed in the detection unit 113 or 115, determination of the presence or absence of a specific component in the sample and measurement of concentration can be performed by performing colorimetry. In this case, it is preferable that the substrate upper portion 103a and the substrate lower portion 103b are formed by a transparent material. This can perform more accurate detection. As a transparent material, specifically, for example, quartz, cyclic polyolefin, PMMA (polymethylmethacrylate), PET (polyethylene terephthalate), or the like can be used.

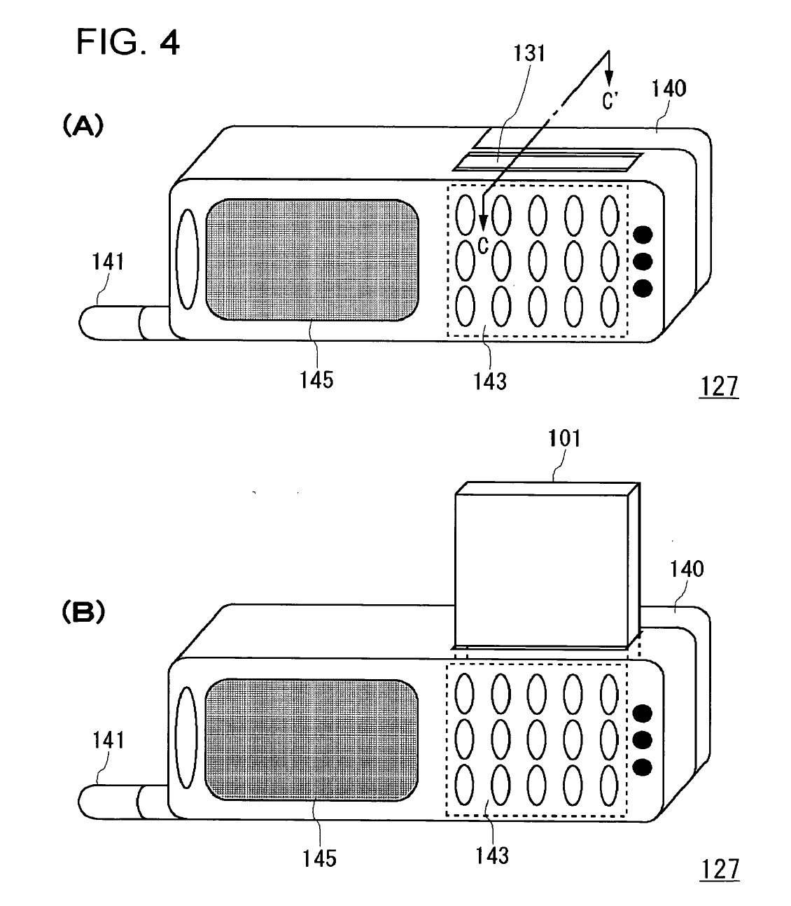

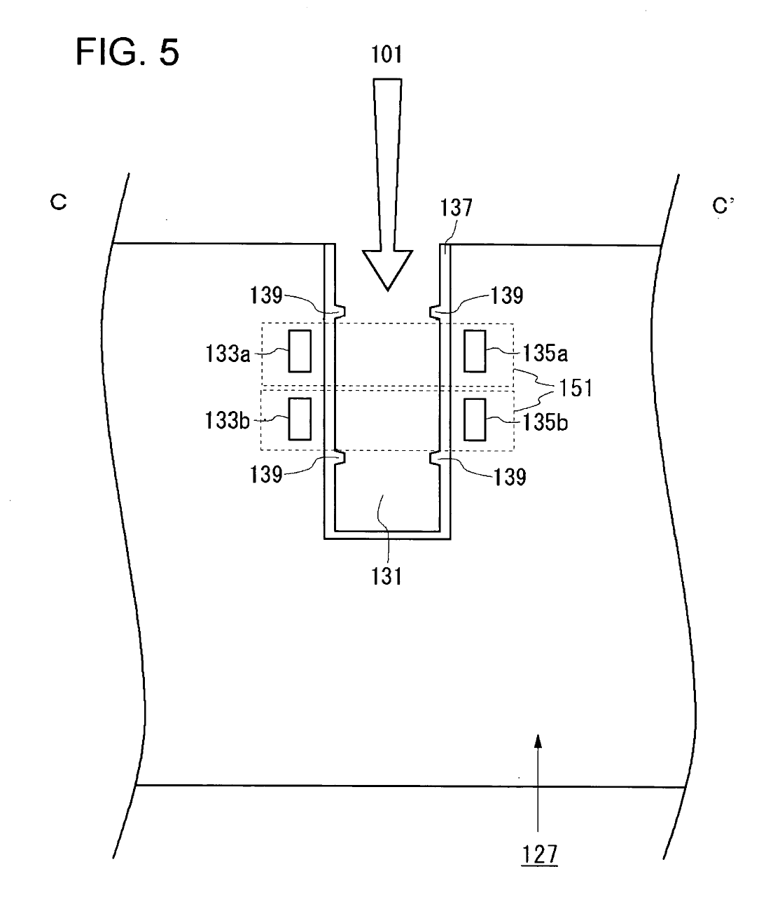

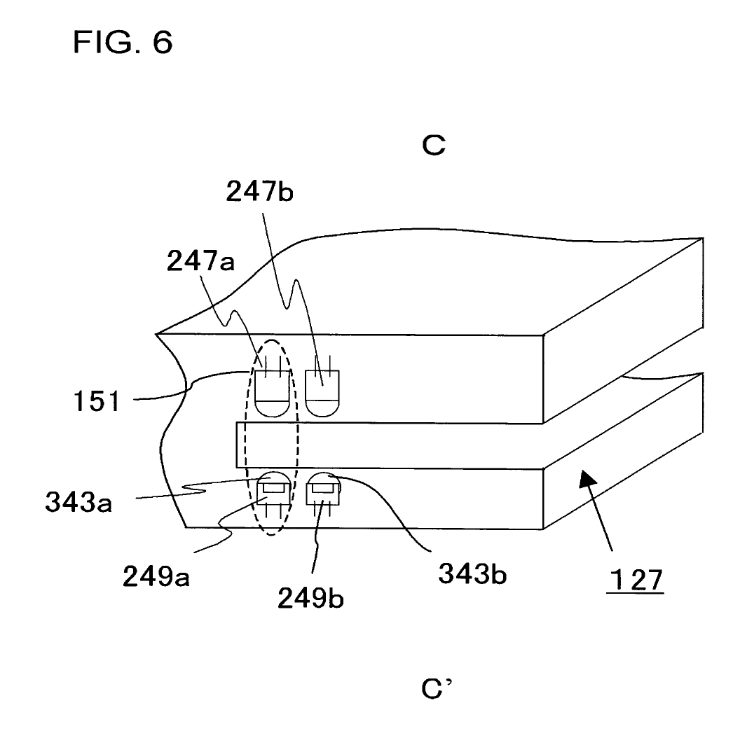

FIG. 4(A) and FIG. 4(B) are views showing an example of configuration of the mobile terminal 127. Here, the case where the mobile terminal 127 is a mobile phone and the measurement unit 151 (shown in FIG. 5 and FIG. 6) is a spectralphotometer will be described as an example. The mobile terminal 127 includes a chip insertion portion 131 in which the chip 101 is inserted. FIG. 4(A) shows a state where the chip 101 is not inserted in the mobile terminal 127 and FIG. 4(B) shows a state where the chip 101 is inserted in the mobile terminal 127. The mobile terminal 127 has a battery pack 140, an antenna 141, a function button group 143, a display unit 145, and the like, as in a mobile terminal such as a general mobile phone or the like.

FIG. 5 is a view showing a cross-section in a direction of the line C-C′ of FIG. 4(A). As shown in FIG. 5, in the mobile terminal 127, the measurement unit 151 is provided at a position corresponding to the detection unit 113 and the detection unit 115 of the chip 101 to be inserted into the chip insertion portion 131. FIG. 5 exemplifies the mobile terminal 127 having two measurement units 151, however, the number of the measurement unit 151 is not limited to this and is suitably selected according to the number of the detection units on the chip 101.

The measurement unit 151 includes a light source 133a or a light source 133b which irradiates light and a light receiving unit 135a or a light receiving unit 135b which detects light from the light sources, respectively. The light source 133a and the light source 133b are arranged at a position capable of irradiating light to the detection unit 113 and the detection unit 115 of the chip 101 when the chip 101 is inserted into the chip insertion portion 131. Furthermore, the light receiving unit 135a and the light receiving unit 135b perform measurement on optical characteristics of liquid accommodated in the detection unit 113 and the detection unit 115.

For example, transmitted light intensity at a wavelength range of approximately 280 to 850 nm in the light source 133a and the light source 133b can be measured. At this time, the light receiving unit 135a and the light receiving unit 135b are placed at a position capable of detecting light transmitted through the detection unit 113 or the detection unit 115. One of the light source 133a and the light source 133b can be used for irradiating light to the reference reservoir.

Packing 137 formed with convex portions 139 is disposed within the insertion portion 131 of the mobile terminal 127 for retaining the chip 101. The chip 101 has concave portions 125 to be fitted to the convex portions 139 of the packing 137 and these portions are fitted, and therefore, the chip 101 can be certainly attached to the chip insertion portion 131. Thereby, light from the light source 133a and the light source 133b is certainly irradiated to the detection unit 113 or the detection unit 115 of the chip 101, and the light transmitted through these units can be certainly received by the light receiving unit 135a and the light receiving unit 135b.

The light receiving unit 135a and the light receiving unit 135b convert intensity of the received transmitted light to current. Although not shown in the drawing, the measurement unit 151 includes a computing unit which calculates transmittance based on the current converted by the light receiving unit 135a and the light receiving unit 135b. The light source 133a and light source 133b can be, for example, a light-emitting diode, laser diode, semiconductor laser, or the like. Furthermore, it may be configured that outgoing light from the light source is introduced to a predetermined position with an optical fiber. Further, the light receiving unit 135a and light receiving unit 135b can be, for example, a phototransistor, photocell, or the like. Still, a photodiode can be used in place of a photocell.

FIG. 6 to FIG. 8 are views showing a cross-section in the direction of the line C-C′ of FIG. 4(A). These drawings show an example of configuration of the measurement unit 151.

In FIG. 6, an LED 247a and an LED 247b correspond to the light source 133a and the light source 133b. Furthermore, a phototransistor 249a and a phototransistor 249b correspond to the light receiving unit 135a and the light receiving unit 135b. Further, a lens 343a and a lens 343b are provided above the phototransistor 249a and the phototransistor 249b, respectively.

Size of each constituent element of the measurement unit 151 is designed in response to shapes or sizes of the detection unit 113 and the detection unit 115 of the chip 101. Here, for example, in the chip 101, depths of the detection unit 113 and the detection unit 115 can be set, for example, approximately 0.1 mm to 1 cm and their clearance can be, for example, approximately 0.5 to 2 mm. At this time, sizes of the LED 247a, LED 247b, lens 343a, lens 343b, phototransistor 249a, and phototransistor 249b are also designed in response to those of the detection units.

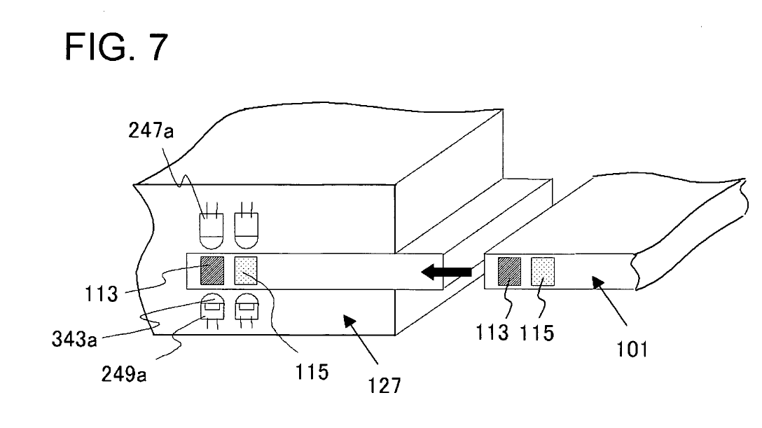

FIG. 7 is a view showing a state where the chip 101 is inserted into the mobile terminal 127 shown in FIG. 4. When the chip 101 is inserted into the insertion portion 131 of the mobile terminal 127, the detection unit 113 and the detection unit 115 are inserted at positions corresponding to the measurement unit 151. Therefore, if the same number of the measurement unit 151 as the detection units formed in the chip 101 is provided, optical measurement at respective detection units can be performed at once. Consequently, measurement can be performed in a short time.

In addition, although not shown in FIG. 5, the mobile terminal 127 can include a spectroscopy unit which disperses light outgoing from the light source 133a and the light source 133b and irradiates light with a predetermined wavelength. This can perform measurement for analyzing abundance of a specific component which has a peak at a specific wavelength.

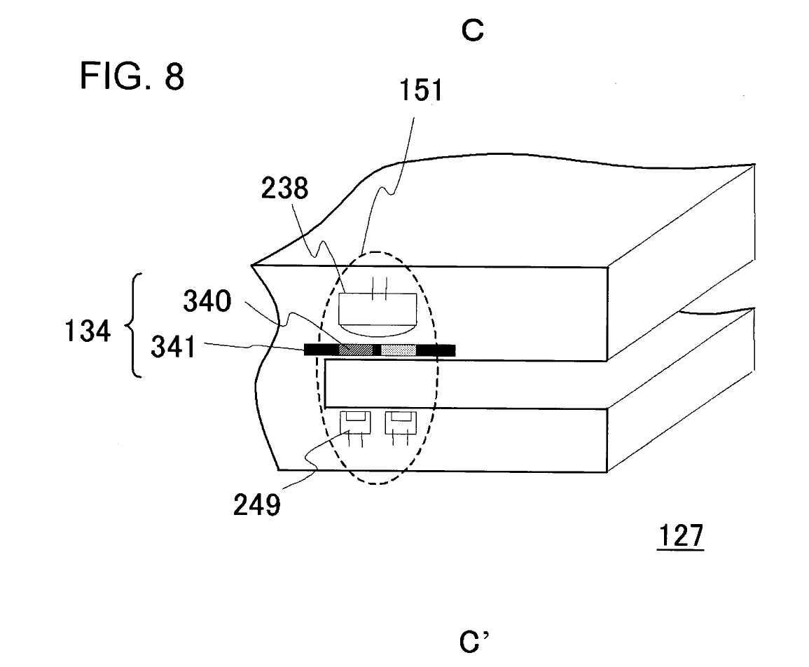

FIG. 8 is a view schematically showing configuration of the measurement unit 151 having a spectroscopy unit. The measurement unit 151 of FIG. 8 is similar in fundamental configuration to the measurement unit 151 of FIG. 6, but there are different points in that the measurement unit 151 of FIG. 8 is provided with one unit of a light source 238 and it includes a spectroscopy unit 134. The spectroscopy unit 134 includes an optical filter 340 and a light shielding plate 341. In addition, in FIG. 8, it is configured that the lens 343a and the lens 343b served as a converging unit are not provided, however, it may be configured that the converging unit is provided.

Of outgoing light from the light source 238, only light in a predetermined wavelength range can be irradiated to the detection unit 113 or the detection unit 115 by providing the optical filter 340. Therefore, when the light source 238 whose wavelength distribution is broad such as a lamp light source is used, measurement can be made by dispersing light with the optical filter 340 corresponding to a measurement wavelength. Furthermore, the optical filter 340 is supported by the light shielding plate 341 and therefore outgoing light from the light source 238 can be prevented from leaking to the other measurement unit 151.

The optical filter 340 can use one, in which a known material as the optical filter is processed to be a predetermined size.

In addition, in the mobile terminal 127 shown in FIG. 6 or FIG. 8, it may be configured that light from an external light source is introduced with optical fiber or the like to irradiate to a position where the detection unit 113 or the detection unit 115 is inserted, without providing the light source. Furthermore, in the aforementioned case, transmittance measured at the detection unit 113 or the detection unit 115 is described, however, it may be configured that the measurement unit 151 measures absorbance and scatterance.

Inspection using a small device and regardless of place can be realized by using the aforementioned chip 101 and the mobile terminal 127.

Furthermore, configuration of the chip 101 and configuration of the mobile terminal 127 are not limited to those described above, but various kinds of configurations can be made.

For example, in the chip 101, the upper surface of the substrate upper portion 103a may be sealed with a seal. The seal may be formed so as to be removal when the chip 101 is used. For example, it may be configured that epoxy-type or silicone-type adhesive agent is coated on the surface of thin film of various kinds of plastic materials. The upper surface of the substrate upper portion 103a is sealed with a seal and therefore it is possible to prevent the chip 101 before use from contaminating and to further accurately measure. Furthermore, the inlet 106 and the air hole 123 of the substrate upper portion 103a are opened by removing the seal by a user and therefore the chip 101 can be immediately used at a timing desired by a user.

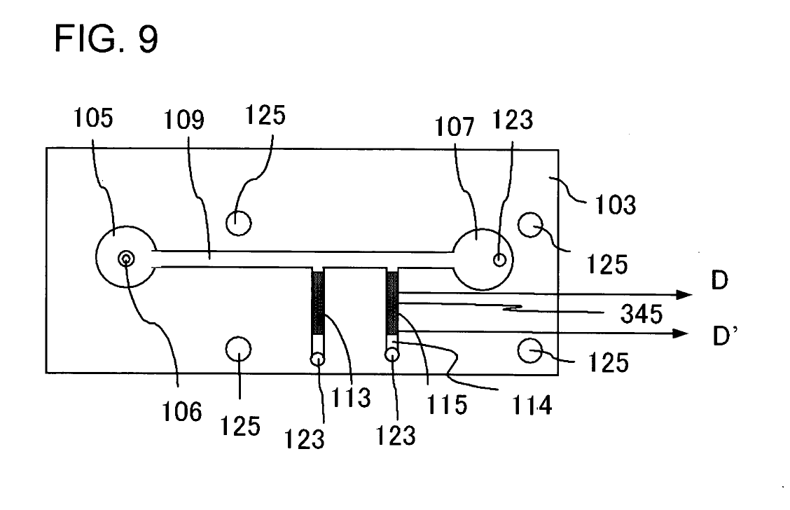

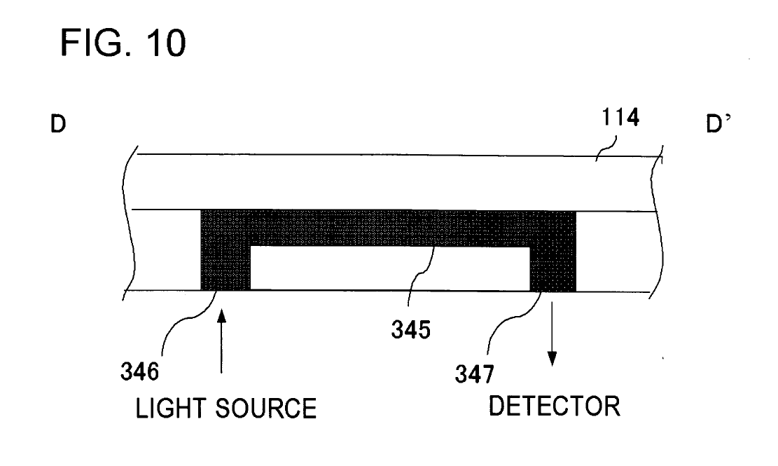

Furthermore, the chip 101 may be configured as shown in FIG. 9 that the detection unit 113 and the detection unit 115 are provided on a dispensing channel 114 and an optical waveguide 345 is formed below these detection units. Here, the optical waveguide 345 can be formed by, for example, quartz-type material or organic polymer material. The optical waveguide 345 is configured so that index of refraction is higher than that of surrounding material. In this case, light is introduced from the bottom surface of the chip to the optical waveguide 345 and, similarly, taken out from the bottom surface of the chip. FIG. 10 is a cross-sectional view taken along the line D-D′ of FIG. 9.

In this case, for example, a light source for introducing light to an optical waveguide for projecting light 346 of the chip and a phototransistor served as a detector (light receiving unit) for receiving light from an optical waveguide for receiving light 347 can be provided on the bottom surface or the like of the mobile terminal 127. In such a configuration, exposed surfaces of the optical waveguide for projecting light 346 and the optical waveguide for receiving light 347 of the chip are brought into contact with the bottom surface or the like of the mobile terminal 127, thereby using the dispensing channel 114 itself as a measuring detection unit 113 or detection unit 115, light can be introduced from the light source of the mobile terminal 127 to the detection unit 113 or detection unit 115 on the dispensing channel 114, and light transmitted through the detection unit 113 or the detection unit 115 can be detected at the light receiving unit of the mobile terminal 127.

Furthermore, in the chip shown in FIG. 9 and FIG. 10, it may be configured that the optical waveguide 345 is not provided. In this case, the optical waveguide for projecting light 346 and the optical waveguide for receiving light 347 are provided, whereby outgoing light from the light source of the mobile terminal 127 is introduced to the detection unit 113 or the detection unit 115 via the optical waveguide for projecting light 346 and outgoing light from the detection unit 113 or the detection unit 115 can be received at the light receiving unit of the mobile terminal 127 via the optical waveguide for receiving light 347. This configuration can also perform optical measurement on predetermined components in liquid dispensed in the detection unit 113 and the detection unit 115. Further, the optical waveguide 345 is not provided and therefore configuration of the chip can be simplified.

In addition, in the case where the chip of the configuration shown in FIG. 9 and FIG. 10 and the chip of the configuration in which the optical waveguide 345 is not provided in this configuration, the mobile terminal 127 may be configured that the light source and the detection unit are respectively provided corresponding to the positions of the optical waveguide for projecting light 346 and the optical waveguide for receiving light 347 in inserting the chip.

Further, it may be configured that the mobile terminal 127 is provided with one unit of the measurement unit 151 and the chip 101 is slided in the chip insertion portion 131 and consequently optical measurement on the detection unit 113 and the detection unit 115 is performed in order.

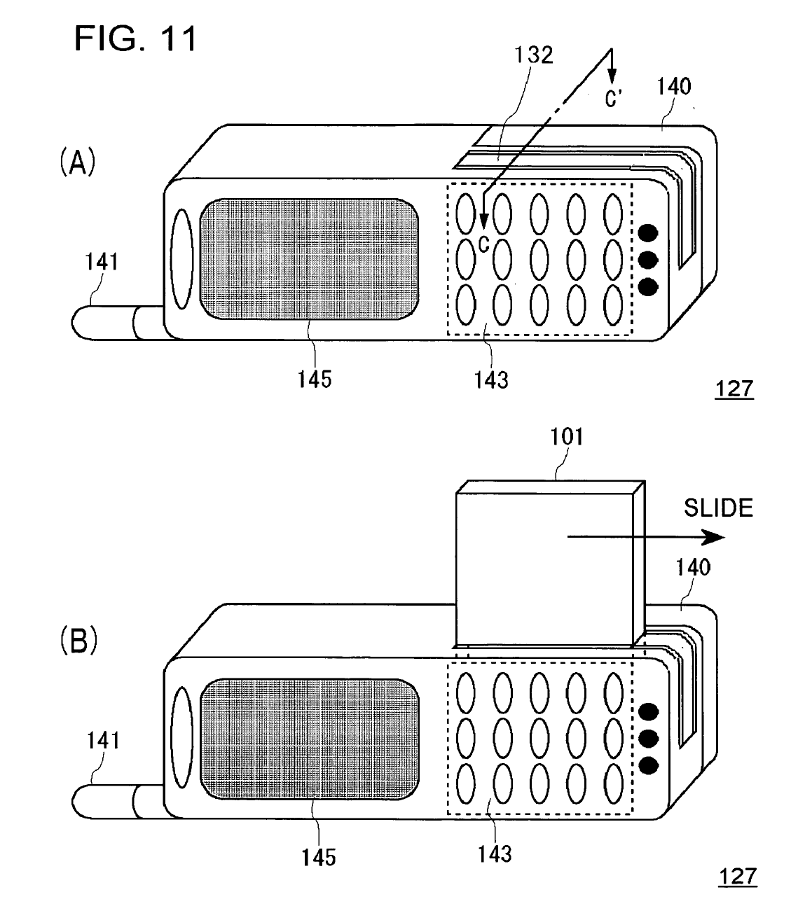

FIG. 11 is a view showing different configuration of the mobile terminal 127. The mobile terminal 127 includes a cutout portion 132. The cutout portion 132 is formed from a side surface to the bottom surface of the mobile terminal 127. When a user slides the chip 101 to the cutout portion 132, transmittance of the detection unit 113 and the detection unit 115 is measured in order.

In this embodiment, the chip 101 having inlet 106, detection unit 113, and detection unit 115 and the mobile terminal 127 are used, whereby a user 187 can readily perform measurement on predetermined components in body fluid on site without installing a large measuring instrument at home and without visiting specialized agencies. If the user 187 possesses the measuring device 129 composed of the chip 101 and the mobile terminal 127, measurement can be performed at a desired time and at a desired place.

Furthermore, the measuring device 129 is small and easy-to-use configuration, and by using this, measurement result on components in body fluid can be certainly obtained with ease by easy-to-use method. Further, measurement result can be transmitted to an external analysis center by the mobile terminal 127 to ask analysis on the measurement result.

Further, the chip insertion portion 131 is provided in the mobile terminal 127 and therefore the chip 101 is used in a disposable mode, whereby the chip 101 can be replaced for every measurement. In addition, measurement can be made without introducing a sample to the mobile terminal 127 itself. Consequently, accurate measurement can be performed without contaminating the mobile terminal 127.

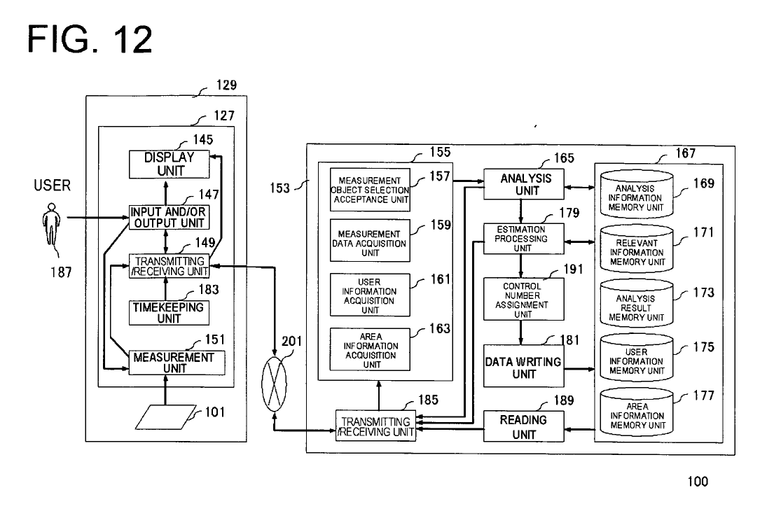

FIG. 12 is a block diagram showing configuration of the inspection system 100. A mobile terminal 127 includes a display unit 145, an input and/or output unit 147, a transmitting/receiving unit 149, a measurement unit 151 acted as measurement unit, and a timekeeping unit 183. The transmitting/receiving unit 149 transmits measurement result measured by the measurement unit 151 as measurement data on health state of a user 187 to an analysis center 153. At this time, data transmitted from the timekeeping unit 183 related to time such as obtained date and hour of measurement value, or the like may be transmitted together.

Furthermore, the transmitting/receiving unit 149 receives analysis result based on the measurement value transmitted from the analysis center 153. The transmitting/receiving unit 149 transmits the received analysis result to the input and/or output unit 147. The input and/or output unit 147 outputs the analysis result to the display unit 145 to present it to the user 187.

The analysis center 153 includes a data acquisition unit 155, an analysis unit 165, a database 167, an estimation processing unit 179, a data writing unit 181, a transmitting/receiving unit 185, a reading unit 189, and a control number assignment unit 191.

Each constituent element of the analysis center 153, in terms of hardware components, is put into practice centering around by a CPU of an arbitrary computer, a memory, a program for substantializing constituent elements of this figure loaded in a memory, a memory unit such as a hard disk for storing the program, and an interface for connecting networks, and those skilled in the art will appreciate that there are various modifications in actualizing its method and device. Each drawing to be explained as follows is not in hardware configuration but shown in function block.

The data acquisition unit 155 includes a measurement object selection acceptance unit 157, a measurement data acquisition unit 159, a user information acquisition unit 161, and an area information acquisition unit 163. The measurement object selection acceptance unit 157 obtains a measurement object selected by the user 187, of information received by the transmitting/receiving unit 185. The measurement data acquisition unit 159 obtains measurement value on the detection unit 113 and the detection unit 115. The user information acquisition unit 161 obtains user ID of the user 187. Furthermore, the area information acquisition unit 163 obtains information on a position in which data is transmitted from the mobile terminal 127.

In addition, the data acquisition unit 155 can obtain measurement data of the user 187 in response to a created position and created date and time of the measurement data. The “created date and time of measurement data” can be set to, for example, date and time in which the user 187 has collected his own body fluid, date and time in which the user 187 has performed measurement on specific components using a chip 101, date and time in which the user 187 has detected coloring of the chip 101 using the mobile terminal 127, or date and time in which the user 187 has transmitted measurement data from the mobile terminal 127. Furthermore, date and time in which the analysis center 153 has obtained measurement data can be set to “created date and time of measurement data.” Such a date and time may be determined based on the timekeeping unit 183 of the mobile terminal 127 or timekeeping function of the analysis center 153, and, it may be determined by input of the user 187.

The “created position of measurement data” can be set to, for example, position information of the mobile terminal 127 when the user 187 using the mobile terminal 127 has transmitted measurement data to the analysis center 153. The position information of the mobile terminal 127 can be obtained using position detection function of base stations of mobile phone networks according to an electric wave receiving state of the mobile terminal 127. Furthermore, in the case where the user 187 possesses the mobile terminal 127 with GPS function, it can be obtained using the GPS positioning function. Further, it enables the user 187 to input position information where the user is present from the mobile terminal 127. The position information of the mobile terminal 127 is transmitted to the analysis center 153 together with measurement data. The position information can be not only two-dimensional information but also three-dimensional information including height.

The analysis unit 165 performs analysis of data obtained by the measurement data acquisition unit 159 on the selected measurement object. Furthermore, the estimation processing unit 179 estimates user's health state based on analysis result at the analysis unit 165.

The control number assignment unit 191 assigns a control number in response to each measurement data. The data writing unit 181 makes the database 167 store various data in response to the control number which is assigned at the control number assignment unit 191. The reading unit 189 reads out information stored in the database 167. The transmitting/receiving unit 185 transmits/receives data to/from the mobile terminal 127.

The database 167 includes an analysis information memory unit 169, a relevant information memory unit 171, an analysis result memory unit 173, a user information memory unit 175, and an area information memory unit 177.

The analysis information memory unit 169 stores a program for analyzing measurement data, reference data, or the like, on a plurality of measurement objects. For example, it stores procedure or a program when the analysis unit 165 analyzes components of the measurement objects and various kinds of programs such as analysis programs or the like which stipulate procedure when the estimation processing unit 179 estimates diseased possibility, on the plurality of measurement objects, respectively. Furthermore, the analysis information memory unit 169 can also store programs for controlling the measurement unit 151. In data structure of the analysis information memory unit 169, evaluation standards for each measurement item can be stored for every ID number of the measurement objects. Specifically, for example, as for a blood sugar level whose measurement item ID is 0002, it may be stored that evaluation is made depending on 4 stage levels of level 1 (−), level 2 (+), level 3 (++), and level 4 (+++) in response to incrementation of value in which transmittance (blank) of the detection unit 113 is subtracted from the transmittance of the detection unit 115.

The relevant information memory unit 171 stores information to be transmitted to the user 187 depending on estimation result at the estimation processing unit 179. For example, information on advice to be transmitted to the user 187 together with result according to the estimation result, information on contact information of medical agencies and insurance companies, and the like can be stored.

The analysis result memory unit 173 stores analysis result by the analysis unit 165 and estimation result at the estimation processing unit 179 in response to control number. Basic data for each measurement object is accumulated in the analysis result memory unit 173.

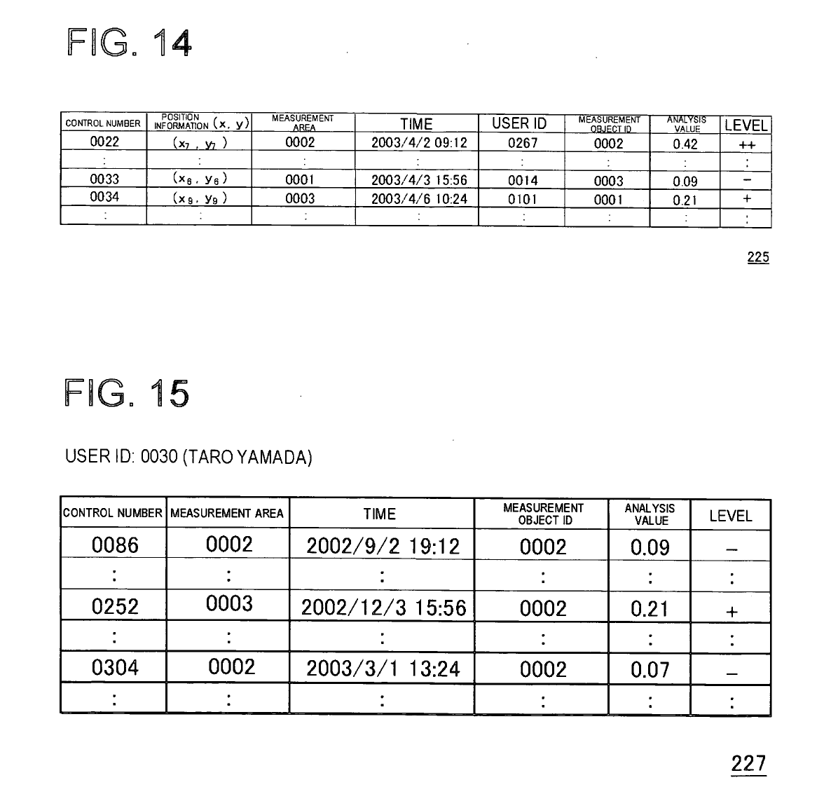

FIG. 14 is a view showing an example of data structure of the analysis result memory unit 173. In data structure 225, position information in which detection is performed, measurement area corresponding to the position information, user ID, analysis value, and onset level are stored in response to control number. For example, diagnosed data of control number 0022 is stored such that analysis value on measurement object 0002 (blood sugar level) is 0.42 and level is ++.

Getting back to FIG. 12, the user information memory unit 175 stores the control number assigned to analysis result in response to the user ID. Thereby, the user 187 can read out change of self-measurement result with time from the mobile terminal 127. FIG. 15 is a view showing an example of data structure of the user information memory unit 175. In data structure 227, analysis value of the user 187 whose ID number is 30, onset level, and measurement area are stored in response to the control number with time. Furthermore, the user information memory unit 175 may store the user ID, user mail address, and the like for every user 187. In addition, when user information is obtained, this should be duly obtained.

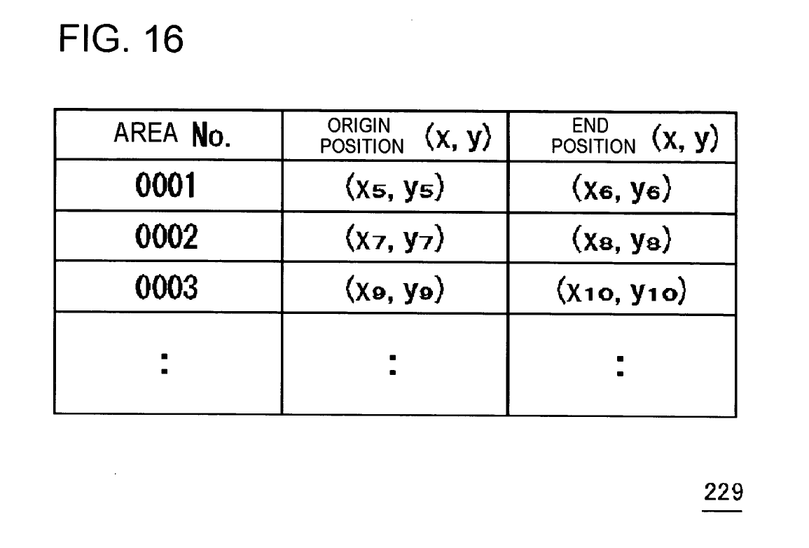

The area information memory unit 177 stores the position information of a plurality of areas. It stores the control number assigned to the analysis result in response to area information. FIG. 16 is a view showing an example of data structure of the area information memory unit 177. An area information memory unit 60 includes an area No. column, an origin position (x, y) column, and an end position (x, y) column. The area No. column corresponds to the area No. column shown in FIG. 14 or FIG. 15, and each area is set to a range bounded by the x-axis and the y-axis, passing through the origin position and the end position, respectively.

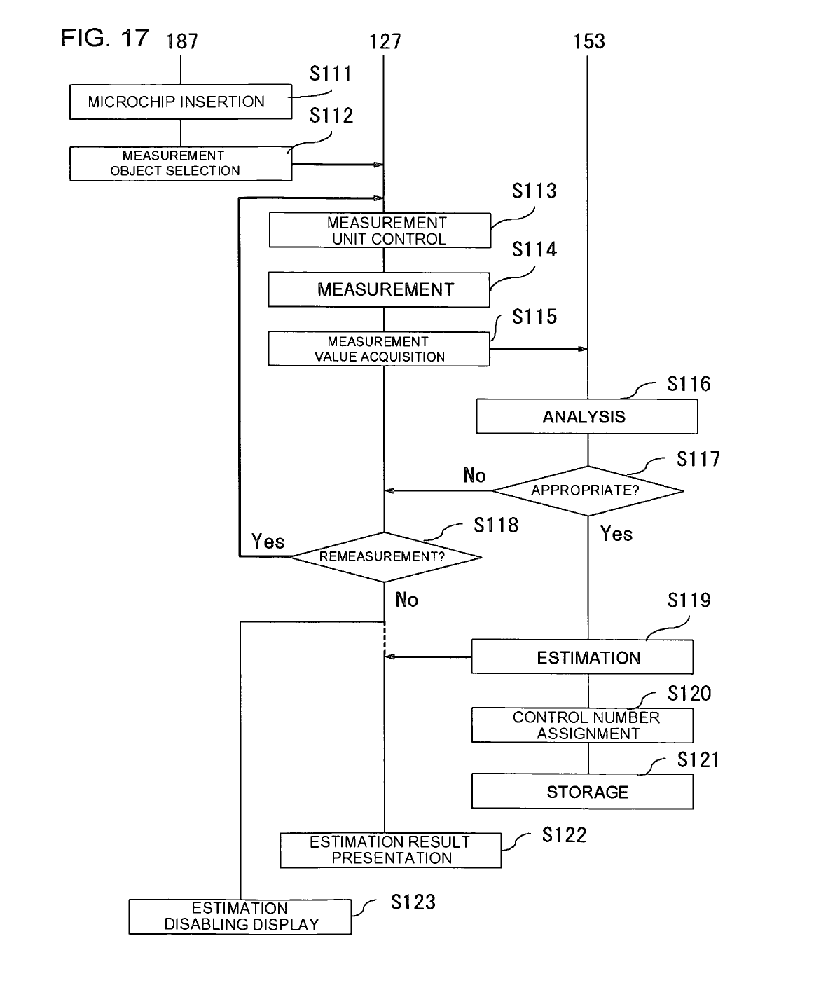

FIG. 17 is a view for explaining processing procedure using the inspection system of FIG. 12. The processing procedure will be described below with reference to including FIG. 12.

The user 187 collects body fluid by the aforementioned method and introduces it to a chip 101. A sample is introduced by capillary phenomenon from a substrate upper portion 103a to a substrate lower portion 103b and introduced to a detection unit. After performing a predetermined color reaction at the detection unit, a chip 101 is inserted to a mobile terminal 127 (S111). Then, a selected measurement object is inputted to an input and/or output unit 147 of the mobile terminal 127 (S112). In this embodiment, the measurement object is not particularly limited, however, items to be described in embodiments below, such as a blood sugar level or the like and items except such items may be included.

The input and/or output unit 147 of the mobile terminal 127 controls a measurement unit 151 for detecting a selected measurement object (S113). For example, in FIG. 5, in the case where the light source 133a or the light source 133b, the light receiving unit 135a or the light receiving unit 135b, or the spectroscopy unit 134 is provided, the spectroscopy unit 134 is controlled. For example, in the case where the measurement object is a blood sugar level, a glucose detection reagent such as NAD (β-nicotinamide adenine dinucleotide, oxidized form), ATP (adenosine triphosphate disodium), hexokinase, glucose-6-phosphate dehydrogenase, and magnesium acetate as a detecting reagent can be included in a detection unit 113 of the chip 101. This enables to measure coloring degree at the detection unit 113 or a detection unit 115 of the chip 101 by the measurement unit 151 of the mobile terminal 127.

Getting back to FIG. 17, transmitted light intensity the detection unit 113 and the detection unit 115 is measured (S114), each measurement value is obtained (S115). When the measurement unit 151 cannot detect the object components, this can be regarded as inability to measure or measurement value of 0%. The obtained measurement value is transmitted from the transmitting/receiving unit 149 to the analysis center 153 (S116). At this time, the measurement object selected by the user 187, user information, and information on a data transmitting area can be transmitted together.

The analysis center 153 receives the information transmitted from the mobile terminal 127 by the transmitting/receiving unit 185 and each data is obtained by the measurement object selection acceptance unit 157 to the area information acquisition unit 163 of the data acquisition unit 155.

The analysis unit 165 analyzes the data obtained by the data acquisition unit 155 (S116). At this time, a program for analyzing the measurement object received by the measurement object selection acceptance unit 157 is obtained from the analysis information memory unit 169. When analysis result is not appropriate (No in S117), this effect is transmitted from the transmitting/receiving unit 185 to the mobile terminal 127. When remeasurement is performed at the mobile terminal 127 (Yes in S118), each step is repeated from the Step 113. Furthermore, when remeasurement is not performed, that effect which is inability to estimate the measurement object by the relevant data is displayed by the display unit 145 (S123) to present it to the user 187.

If appropriate analysis result is obtained (Yes in S117), diseased possibility is estimated by an estimation processing unit 179 (S119). Estimation result is assigned with a control number by the control number assignment unit 191 and then stored in the database 167 by the data writing unit 181.

Furthermore, the estimation result is transmitted from the transmitting/receiving unit 185 to the mobile terminal 127. At this time, information stored in the relevant information memory unit 171 may be transmitted together. The mobile terminal 127 displays the result received by the transmitting/receiving unit 149 in the display unit 145 to present it to the user 187 (S122).

According to the inspection system 100, the chip 101 is inserted to the mobile terminal 127, whereby measurement of components in body fluid can be conveniently performed by a simple device configuration. Furthermore, a large exclusive use instrument need not to be installed at home and therefore the user 187 can perform measurement even at a place where the user is out. Further, the user need not visit specialized analysis agencies.

Furthermore, measurement value and estimation result are transmitted/received between the mobile terminal 127 and the analysis center 153 and therefore device configuration of the mobile terminal 127 can be simplified to the essentials. Further, the user 187 can transmit measurement result on his/her own body fluid and receive analysis result without visiting analysis centers or medical agencies at a remote place. Consequently, the user 187 can confirm his/her own health state at a desired place.

Further, the analysis center 153 can cyclopaedically comprehend analysis data on a plurality of measurement objects according to users, areas, and measurement objects.

In addition, in FIG. 3, the chip 101 can be used for much measurement by arbitrarily differentiating a detecting substance to be attached to the detection unit 113 or the detection unit 115. Two detection units of the detection unit 113 and the detection unit 115 are formed in the chip 101, but the number of the detection unit 115 is not particularly limited. Further, a different detecting substance may be attached to each detection unit of one sheet of the chip 101. This enables the user 187 to perform measurement on a plurality kinds of components by one measurement and transmit from the mobile terminal 127. Therefore, multiple analysis result based on measurement result on the plurality of components can be received by one measurement.

Furthermore, a reservoir communicated to the channel 109 is further provided in the chip 101 and sample dilution buffer is introduced in the reservoir or introduced at a predetermined timing, whereby the sample introduced to the sample introducing unit 105 is diluted and then can be introduced to the detection unit 113 and the detection unit 115. This enables to dilute the sample to concentration suitable for measurement by the measurement unit 151 and therefore it becomes possible to perform high-sensitivity measurement.

Multiple processing can be applied to a sample by performing a predetermined operation such as dispensation and dilution on the chip 101 and therefore the sample in a state suitable for measurement at the measurement unit 151 can be introduced to the detection unit 113 and the detection unit 115. Therefore, components which have been measured using accurate measuring devices in the past can be also readily measured using the measuring device 129.

Furthermore, in FIG. 5, it is configured so that the mobile terminal 127 detects transmitted light of the detection unit 113 and the detection unit 115, however, it may be arranged so that the light receiving unit 135a and the light receiving unit 135b are configured to detect reflected light.

(Second Embodiment)

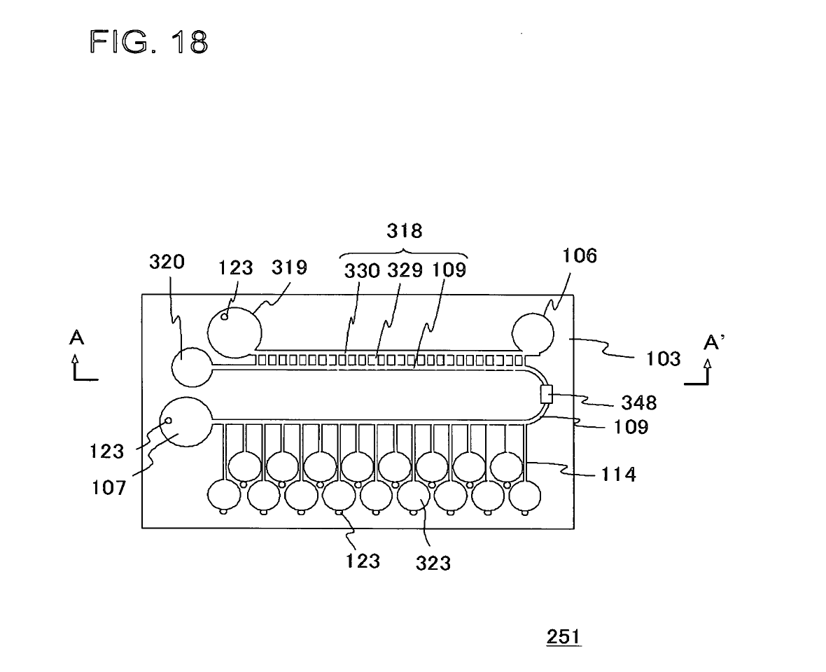

This embodiment relates to other configuration of chip applicable to the inspection system 100 (FIG. 1) described in the first embodiment. FIG. 18 is a view schematically showing configuration of chip according to this embodiment. A chip 251 of FIG. 18 is a chip which can perform separation and detection of a sample and fundamental configuration is the same as the chip 101 of FIG. 3, however, a separation region 318, a waste solution reservoir 319, a buffer inlet 320, a channel 330, and a mixing unit 348 are further included. Furthermore, a plurality of detection units 323 correspond to the detection unit 113 and the detection unit 115 in the chip of FIG. 3.

The separation region 318 includes the channel 330 communicated to a channel 109 via the channel 109 and a plurality of fine channels 329 and is configured filter-shaped. The waste solution reservoir 319, which is communicated to the channel 330 and discharges an unnecessary sample, is provided. Furthermore, the buffer inlet 320 communicated to the channel 109 is provided. In addition, FIG. 18 exemplifies the chip 251 whose separation region 318 is designed filter-shaped, however, configuration of the separation region 318 is not limited to this, for example, it may be configured that a plurality of columnar bodies are arranged in the channel.

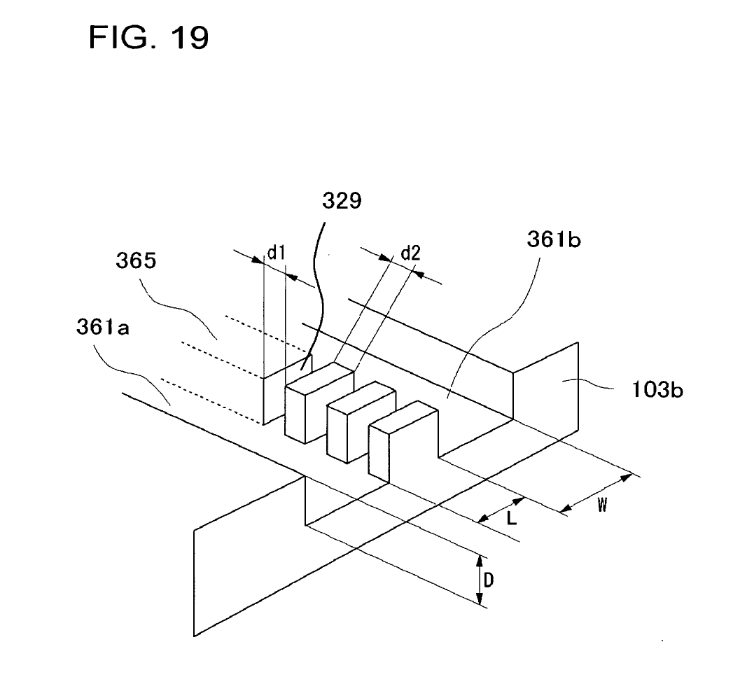

FIG. 19 is a view explaining configuration of the separation region 318. In FIG. 19, a channel groove 361a and a channel groove 361b (both grooves with width W and depth D) are provided on the substrate lower portion 103b and a partition wall 365 intervenes therebetween. Here, one of the channel groove 361a and the channel groove 361b becomes the channel 109, and the other becomes the channel 330. In the partition wall 365, separation channel is regularly formed. The term “separation channel” here is configuration corresponding to the fine channels 329. The separation channel is orthogonal to the channel groove 361a and the channel groove 361b and the separation channel with width d1 is regularly formed at a predetermined distance d2. Each dimension shown in the drawing is set to an appropriate value in response to a separated sample or the like, for example, a preferable value is selected from the following range.
W: 10 μm to 1000 μm
L: 10 μm to 1000 μm
D: 50 nm to 1000 μm
d1: 10 nm to μm
d2: 10 nm to μm

Of those, a value L corresponding to the separation channel directly affects on separation characteristics and therefore it is important to accurately design according to separation purpose. For example, in separation of macromolecules, the conformation of the molecules changes when passing through the separation channel and generates enthalpy change. Therefore, there arises a difference in total amount of enthalpy change associated with passing of the molecule according to the length of the separation channel, resulting in change in separation characteristics. Since the present invention has the channels configured by grooves, they can be manufactured by etching or molding processing and therefore shape and size can be precisely controlled. As a result, the separation region 318 with predetermined separation characteristics can be stably manufactured. In addition, the channel groove 361a, the channel groove 361b, and the separation channel can be formed by various methods, and in the case where values of d1 and d2 are set to not more than 100 nm, it is preferable to use dry etching combined with electron beam exposure technology in view of fine-processing property.

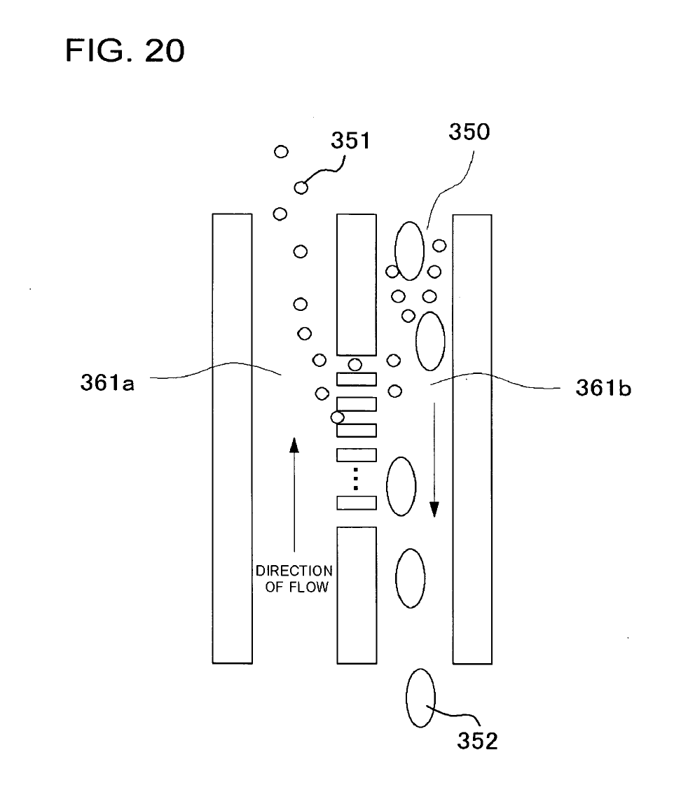

A separation method using the separation region 318 of structure shown in FIG. 19 will be described with reference to FIG. 20. FIG. 20 is a view schematically showing a schematic configuration when the separation region 318 is viewed from above. First, as preparation before performing separation of a sample, buffer solution served as carrier is filled in each channel groove. In FIG. 20, undiluted solution of sample including a composite 350 flows in the channel groove 361b in downward direction in the drawing. Then, small molecules 351 in the composites pass through the separation channel provided in the partition wall shown at the center of the drawing and go into the adjacent channel groove 361a. Solvent which does not generate chemical reaction with the separation object component flows in the channel groove 361a in upward direction in the drawing. Therefore, small molecules 351 entered in the channel groove 361a are carried along the flow in upward direction in the drawing. On the other hand, since large molecules 352 in the channel groove 361b cannot pass through the separation channel, such molecules 352 directly flow in the channel groove 361b and are recovered at the end of the channel. As described above, small molecules 351 are separated from large molecules 352.

In FIG. 20, flow directions in the channel groove 361a and the channel groove 361b are reversed. Although the same direction can be made, in the case where the flow directions are reversed, separation efficiency improves. For example, in the case where the direction in the channel groove 361a is in downward direction in the drawing, concentration of small molecules 351 become high as it goes toward the flow direction. Therefore, a difference in concentration among the large molecules 352 in the channel groove 361a and the channel groove 361b becomes low as it goes toward the flow direction, and both concentrations become equivalent at a certain point. In an anterior region from this point, it is less likely to move the large molecules 352 from the channel groove 361b to the channel groove 361a, so that separation cannot be made. On the other hand, in the case where the flow directions are reversed as in this embodiment, a difference in concentration between large molecules 352 in the channel groove 361a and the channel groove 361b is secured and therefore high separation performance can be ensured even when the separation channel is formed over a region with a certain length.

Furthermore, in the aforementioned configuration, the partition wall formed with a plurality of fine channels 329 served as the separation channel are shown, however, a separation region 318 may be configured so that a bank unit is provided as to be shown below.

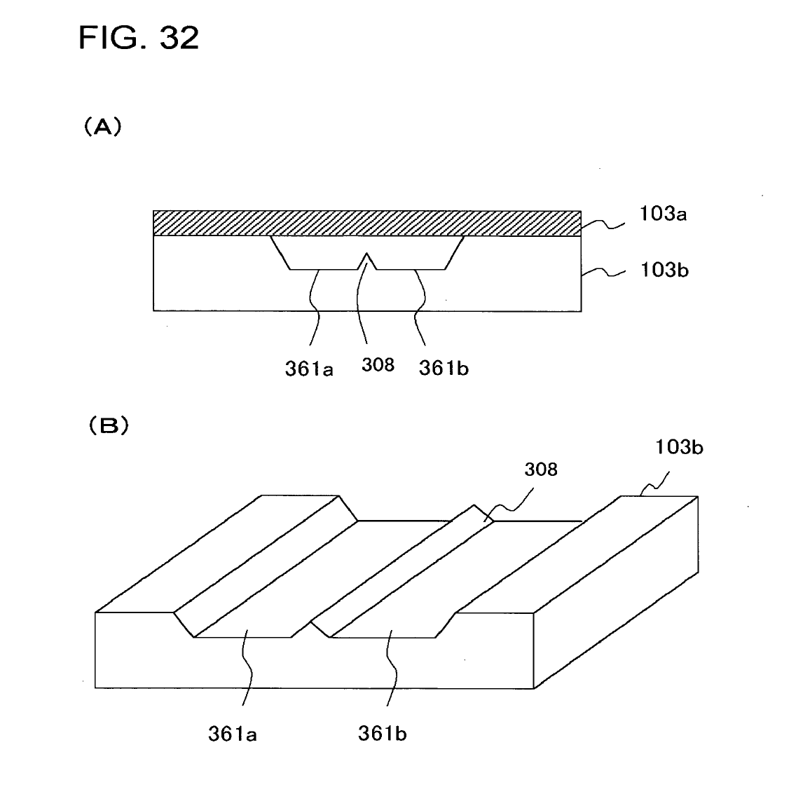

FIG. 32(A) and FIG. 32(B) are views showing configuration of the separation region 318. FIG. 32(A) and FIG. 32(B) show a cross-sectional view and a perspective view, respectively. As shown in FIG. 32(A), two channel grooves, namely the channel groove 361a and channel groove 361b, are provided on a substrate lower portion 103b and a partition wall 308 corresponding to the bank unit is provide so as to divide them. A substrate upper portion 103a is arranged on the substrate lower portion 103b. The substrate upper portion 103a is not shown in FIG. 32(B) for convenience sake.

As seen from FIG. 32(A), space is secured between the substrate upper portion 103a and the substrate lower portion 103b and therefore the channel groove 361a and the channel groove 361b are communicated with each other via the space. The space corresponds to the separation channel provided on the partition wall 365 of the above-described separation region 318. Therefore, for example, a sample including a separation object substance flows in the channel groove 361a and buffer solution flows in the channel groove 361b, thereby enabling to perform separation operation.

In addition, in this case, it is preferable to select those made of hydrophobic material such as polydimethylsiloxane and polycarbonate for the substrate upper portion 103a. Thereby, a sample or the buffer solution can be introduced to each channel groove without entering into the other. channel groove, and in a state where the sample or the like is filled in both channel grooves, mixture of the sample and the buffer solution can be generated in both channel grooves via the above-mentioned space. Such effect can be also obtained by performing operation in a state where the substrate upper portion 103a is not mounted. At this time, it is considerable that air itself acts as a hydrophobic substance as in the substrate upper portion 103a.

Furthermore, in a state where the substrate upper portion 103a made of hydrophilic material such as polyethylene terephthalate is mounted, for example, when a sample flows in the channel groove 361a, the relevant sample enters into the other channel groove 361b. When this entering is occurred, only a component whose size is smaller than the space formed between the substrate upper portion 103a and the partition wall 308 is strained and therefore separation of components in a sample is realized.

According to this configuration, the partition wall 308 is provided, whereby separation efficiency can be improved because the channel groove 361a and the channel groove 361b are connected by wide areas compared to the partition wall 365 having the fine channels 329. Furthermore, it is less likely to clog even if a long and thin substance is used and it can be readily moved between the channels, and therefore, it can be suitably used for separation of sample including such a substance.

Such channel groove 361a, channel groove 361b, and partition wall 308 can be obtained by processing (100) Si substrate with wet etching, for example. When (100) Si substrate is used, in the direction perpendicular or parallel to <001> direction, etching progresses in the form of trapezoid as shown in the drawing. Therefore, a height of the partition wall 308 can be adjusted by controlling etching time.

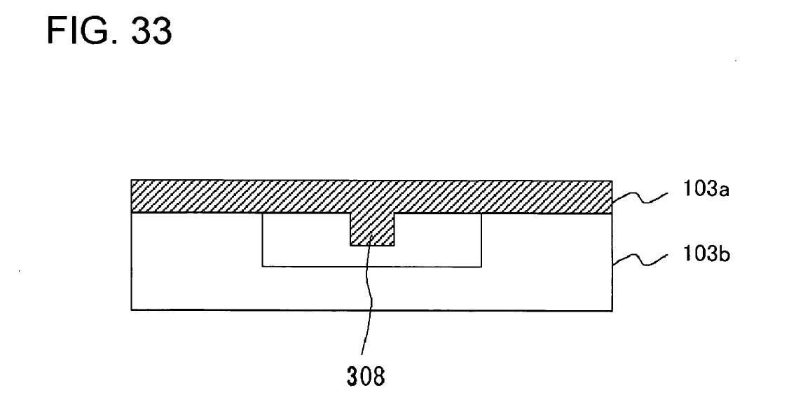

Furthermore, as shown in FIG. 33, the partition wall 308 can be provided on the substrate upper portion 103a. The substrate upper portion 103a provided with such partition wall 308 can be readily obtained by processing resin such as polystyrene with injection molding. Further, only one channel may be provided in the substrate lower portion 103b by etching or the like. Therefore, this separation region 318 can be obtained by convenient processing described above and consequently it is suitable for mass production.

The separation region 318 of this embodiment, for example, can be separated by introduction and diffusion due to capillary phenomenon of undiluted solution of sample. Furthermore, separation can be made using osmotic pressure difference of a molecule.

Getting back to FIG. 18, a sample introduced to an inlet 106 is introduced to the channel 330 by capillary phenomenon. When the sample is filled in the channel 330, a predetermined buffer is introduced to the buffer inlet 320. The buffer is used as separating developer of components in the sample. The buffer introduced to the inlet 320 is introduced to the channel 109 by capillary phenomenon moves in a reverse direction to a moving direction of the sample in the channel 330.

Here, since the fine channels 329 communicated to the channel 330 and the channel 109 are smaller in width or depth than the channel 330, of sample components in the channel 330, only components having a predetermined size or shape pass through the fine channels 329 and can move to the channel 109. Furthermore, components which cannot pass through the fine channels 329 are discharged to the waste solution reservoir 319. In this way, components in a sample can be separated according to size or shape in moving phase. In addition, the fine channels 329 can have partition walls for partitioning the channel 330 and the channel 109, the partition wall being provided with small holes.

For example, rough separation, purification, or the like of the sample can be performed by using such separation region 318. In the case of rough separation, a solid component, cell, or the like in a sample can be separated and removed. Furthermore, in the case of liquid sample, for example, it is possible to perform separation or the like between a low molecule mass component and a high molecular weight component.

Furthermore, this chip includes a mixing unit 348, which homogenizes sample concentration prior to detection or measurement, between the separation region 318 and the detection unit 323. If the mixing unit 348 is configured so that sample component concentration in liquid flowing in the channel 109 can be homogenized, it is not particularly limited, and it may be configured in the following way, for example.

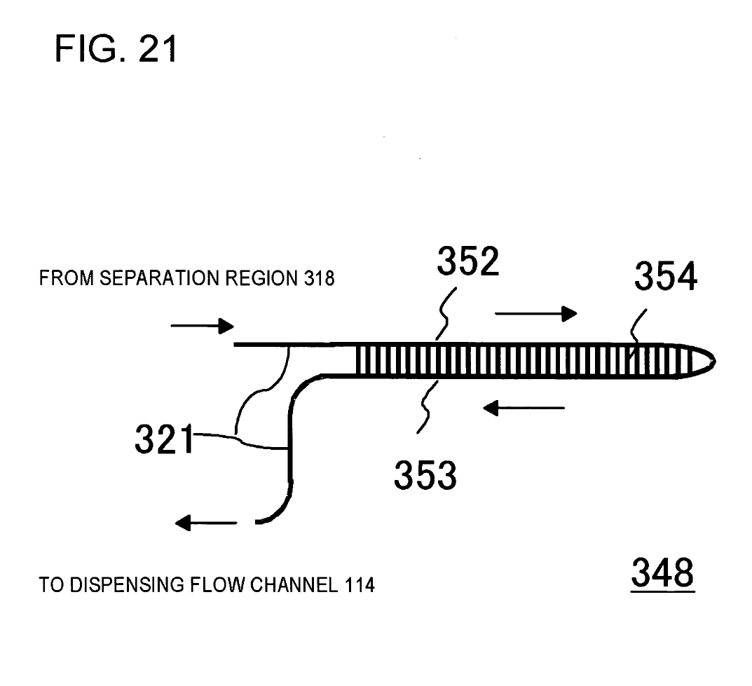

FIG. 21 is a view showing an example of configuration of the mixing unit 348. The mixing unit 348 of FIG. 21 is an entrance channel using homogenization effect by counterflow. The channel is configured so that an outward channel 352 and a homeward channel 353 of a channel 109 are communicated by the fine channels for mixing 354. The fine channels for mixing 354 can be, for example, small holes provided on partition walls which partitions the outward channel 352 and the homeward channel 353.

The surface of the fine channels for mixing 354 are hydrophobic compared to the outward channel 352. Thereby, it can be configured that liquid passed through the separation region 318 does not flow into the homeward channel 353 from the fine channels for mixing 354 before filling the liquid in the outward channel 352. When the liquid fills the outward channel 352 and reaches the homeward channel 353, the liquid enters into the fine channels for mixing 354 from the outward channel 352 side and the homeward channel 353 side, whereby the outward channel 352 and the homeward channel 353 are communicated by the fine channels for mixing 354. Then, mutual diffusion is generated between the liquid in the outward channel 352 and the liquid in the homeward channel 353 and consequently liquid concentration can be homogenized. The homogenized liquid is introduced from the channel 109 to the detection unit 323 via a dispensing channel 114.

This configuration enables concentration of liquid flown to the dispensing channel 114 after passing through the homeward channel 353 to be homogenized. Therefore, even when sample component concentration in body fluid after passing through the separation region 318 is uneven, sample component concentration in liquid to be supplied to a plurality of detection units can be constant. Consequently, accuracy of detection reaction can be improved.

For example, in the case where region in high sample component concentration is present at the tip region of liquid flowing in the channel 109, the more liquid proceeds in the outward channel 352, the more the liquid replaces by already diluted and low concentration liquid in the homeward channel 353 and is homogenized to be average concentration. On the contrary, in the case where high concentration region is far away from the tip of liquid flowing in the channel 109 and is present at the outward channel 352 after liquid enters into the homeward channel 353, low concentration liquid proceeding in the homeward channel 353 is mixed with high concentration liquid in the homeward channel 353 and is homogenized to be average concentration. In addition, in FIG. 21, the channel 109 is straight-shaped, but it may be in a zig-zag shaped or in a spiral shaped configuration. This enables the mixing unit 348 to be compact. Consequently, the whole chip can be reduced in size.

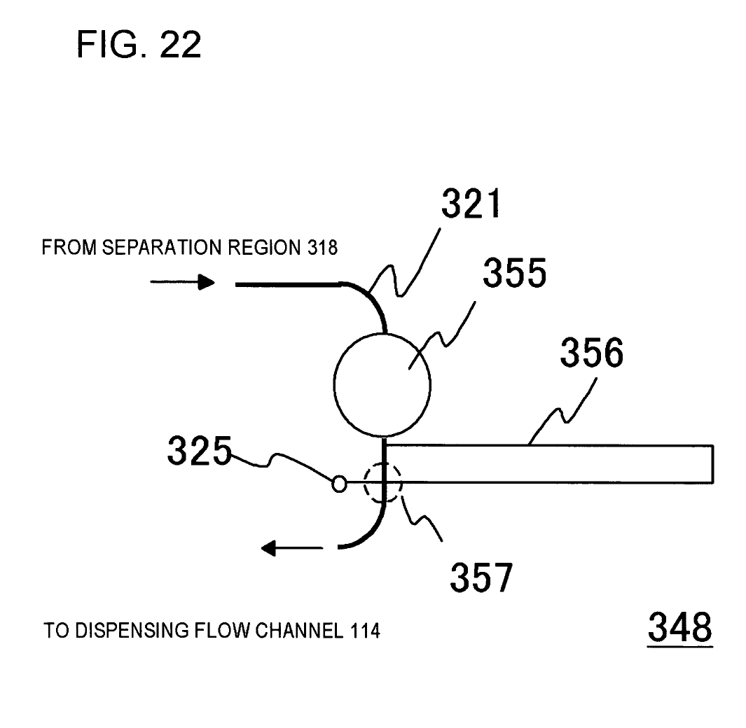

Further, FIG. 22 is a view showing different configuration of a mixing unit 348. In the mixing unit 348 of FIG. 22, a reservoir 355 is provided in a channel 109, and a trigger channel 356 which makes two portions of the channel 109 communicate is provided in the downstream of the reservoir 355. The trigger channel 356 can adjust proceeding speed in the channel by suitably adjusting hydrophilic degree in the channel, a channel diameter, and the like. Thereby, speed of switching operation can be adjusted. Of two cross-points between the trigger channel 356 and the channel 109, a liquid switch 357 is provided on the downstream side, that is, at the cross-point of the dispensing channel 114 side.

In such a mixing unit 348, the liquid switch 357 closes at first, liquid passed through the separation region 318 is stored in the reservoir 355 and concentration is homogenized. When the reservoir 355 is filled with the liquid, one portion of which flows into the trigger channel 356. Then, when the liquid fills in the trigger channel 356 and reaches the forming region of the liquid switch 357, the liquid switch 357 opens, and therefore liquid homogenized in the reservoir 355 flows into the dispensing channel 114.

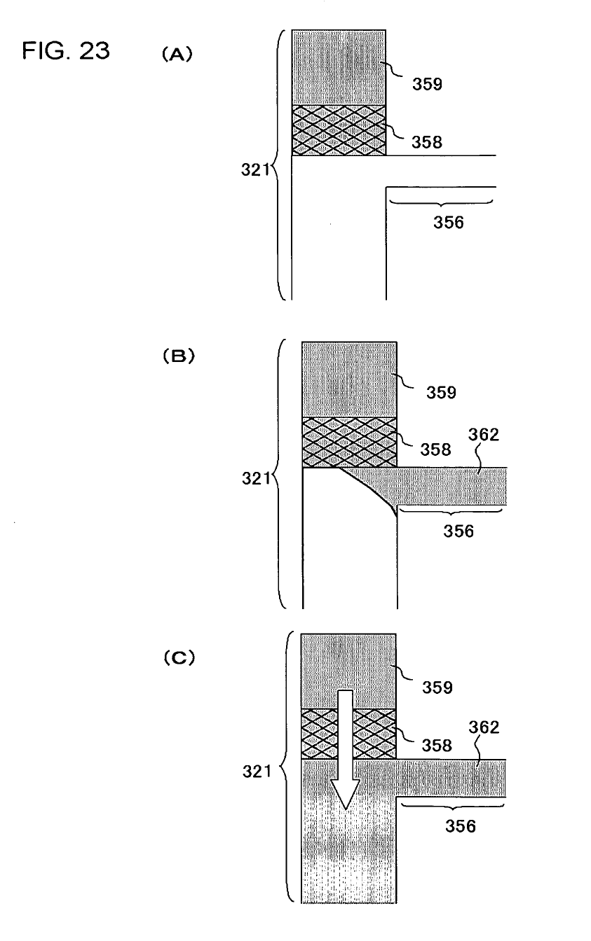

FIG. 23(A) to FIG. 23(C) are partially enlarged top views of the liquid switch 357 of FIG. 22. The liquid switch 357 is a switch for controlling liquid flow and the liquid is a trigger for switching. FIG. 23(A) shows a switch-on state and FIG. 23(B) and FIG. 23(C) show a switch-off state. In the drawings, the trigger channel 356 is connected to the side of the channel 109. The trigger channel 356 can adjust proceeding speed of the liquid in the channel by suitably adjusting hydrophilic degree in the channel, a channel diameter, and the like. Thereby, speed of switching operation can be adjusted. A damming unit 358 is provided on an upstream side (upper side in the drawing) of an intersection region of the channel 109 and the trigger channel 356. The damming unit 358 is a portion where capillary attraction is stronger than other portion of the channel. As for specific configuration of the damming unit 358, the following is exemplified.
(i) Configuration Arranged with a Plurality of Columnar Bodies

In this configuration, a channel superficial area per channel unit volume in the damming unit 358 is larger than that of the other portion of the channel. That is, when liquid is filled in the channel 109, the damming unit 358 is configured so that a solid-liquid interface is larger than the other portion of the channel.
(ii) Configuration Filled with a Plurality of Porous Bodies and Beads

In this configuration, the damming unit 358 is configured so that a solid-liquid interface is larger than the other portion of the channel.

In the case of configuration of the above-mention (i), a columnar body can be formed by suitable methods according to kinds of substrates. In the case of using a quartz substrate and a silicon substrate, they can be formed using photolithography technology and dry etching technology. In the case of using a plastic substrate, a metal mold having a reversal pattern of a columnar body pattern to be formed is produced, and a desired columnar body pattern surface can be obtained by molding with this metal mold. In addition, such a metal mold can be formed by using photolithography technology and dry etching technology.

In the case of configuration of the above-mention (ii), a porous body and beads can be formed by directly filling and adhering in a predetermined portion of the channel.

This embodiment adopts the configuration of the above-mention (i).

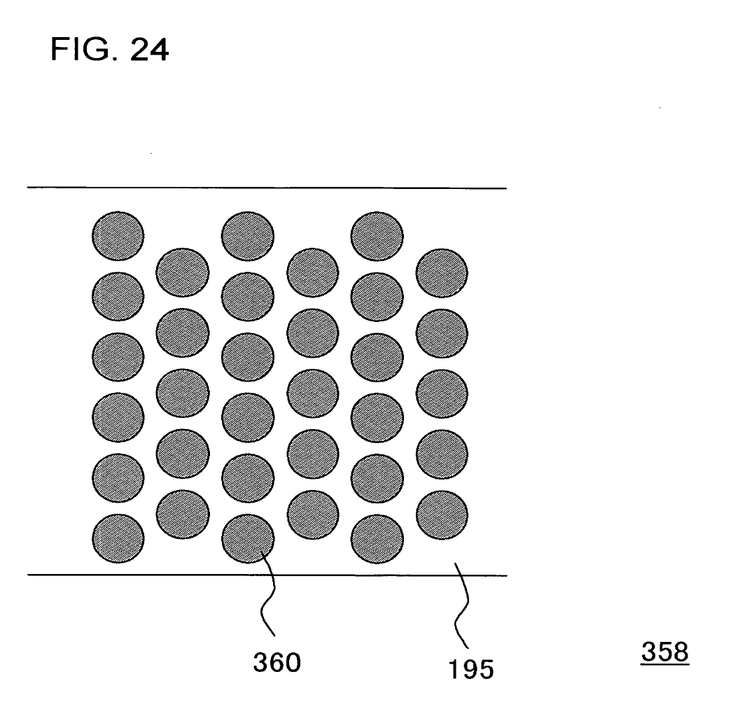

FIG. 24 is a top view of a damming unit 358. A plurality of columnar bodies 360 are regularly arranged at substantially even intervals. Regions except the columnar bodies 360 are fine channels 195. A channel superficial area per channel unit volume in the damming unit 358 is larger than that of the other portion of the channel. Therefore, liquid entered into the damming unit 358 is retained in the fine channels 195 by capillary attraction.

FIG. 23(A) shows the liquid switch 357 in a standby state. A liquid sample 359 introduced to the channel 109 is retained at the damming unit 358. From this state, when trigger liquid 362 diverted in the trigger channel 356 at a desired timing is introduced, tip of the liquid surface of the trigger liquid 362 proceeds as shown in FIG. 23(B) to come in contact with the damming unit 358. In the state of FIG. 23(A), the liquid sample 359 is retained in the damming unit 358 by capillary attraction, however, when the liquid sample 359 comes in contact with the trigger liquid 362 as in the state of FIG. 23(B), the liquid sample 359 moves in downward direction in the drawing (downstream side) and the liquid sample 359 flows out on the downstream side of the channel 109 of FIG. 23(C). That is, the trigger liquid 362 serves as priming water to activate as the liquid switch which extracts the liquid sample 359 to the downstream side.

As described above, the liquid sample 359 and the trigger liquid 362 are liquid passed through the reservoir 355. Therefore, according to this configuration, while liquid passed through the separation region 318 fills the reservoir 355 and further reaches the tip of the trigger channel 356, that is, the cross-point on the downstream side of the channel 109, the liquid can be made not to enter into the dispensing channel 114 side. Consequently, sample component concentration can be certainly homogenized at the reservoir 355. Further, timing flowing into the dispensing channel 114 can be suitably adjusted by configuration of the trigger channel 356.

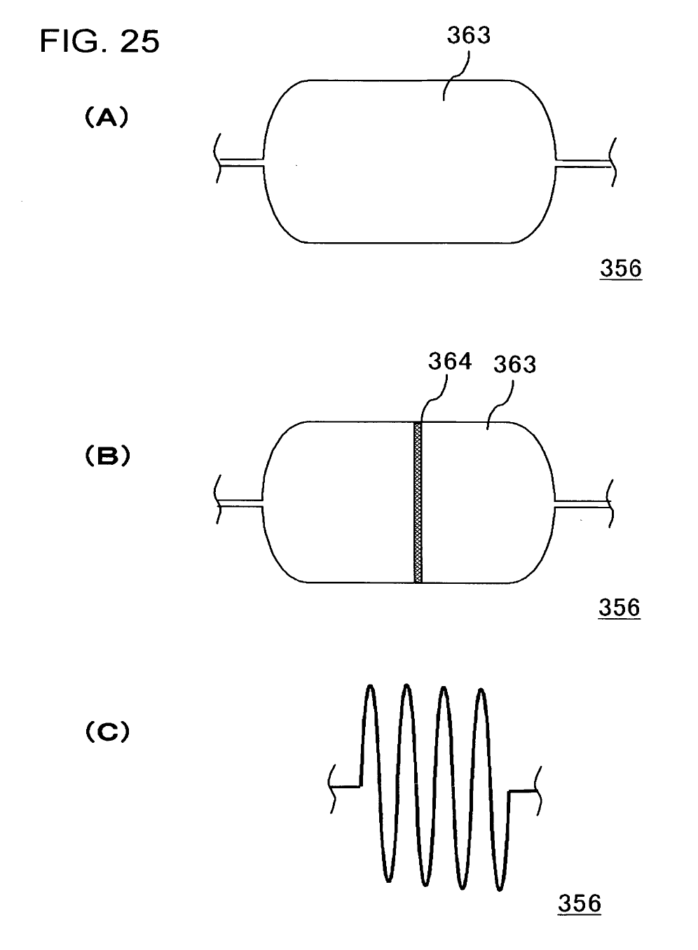

FIG. 25(A) to FIG. 25(C) are views for exemplifying trigger channels 356. In FIG. 25(A), a channel-expanded region 363 is formed at one portion of a trigger channel 356. The channel-expanded region 363 acts as a time-lag reservoir in the trigger channel 356. Thereby, timing for opening a liquid switch 357 can be delayed.

In the trigger channel 356 of configuration of FIG. 25(A), FIG. 25(B) shows a hydrophobic region 364 formed in the channel-expanded region 363. The hydrophobic region 364 is formed in a direction perpendicular to a proceeding direction of liquid in the trigger channel 356 so as to traverse the channel-expanded region 363. Such a hydrophobic region 364 is provided and therefore liquid can be suppressed to reach the other side along only wall surface in the channel-expanded region 363.

FIG. 25(C) shows an example of a zig-zag shaped trigger channel 356. As shown, shape and length of the trigger channel 356 is optimized and therefore a liquid switch 357 can be released at a desired timing. Shape of the trigger channel 356 is not limited to the shape of FIG. 25(C) if its shape is small in occupied area, for example, it may be formed in spiral shape.

Sample components in the channel 109 are introduced from the dispensing channel 114 communicated to the channel 109 to the detection unit 323. Also in this embodiment, the dispensing channel 114 and the detection unit may be provided on the substrate lower portion 103b by a predetermined number. In the chip 251 of FIG. 18, a plurality of dispensing channels 114 are branched from the channel 109, the dispensing channel 114 is a thinner channel than the channel 109 and therefore sample components are introduced by capillary phenomenon in order from the detection unit 323 communicated to the dispensing channel 114 of upstream side. Furthermore, unnecessary sample after sample components are introduced to all the detection units are discharged to the reservoir 107.

According to the chip 251 of this embodiment, the separation region 318 is provided between the sample introducing unit 105 and the detection unit 323 and therefore predetermined components included in samples introduced to the sample introducing unit 105 can be certainly separated and introduced to the detection unit 323. Therefore, as for also a small amount of components, background in measuring can be decreased to perform high sensitivity measurement.

Further, the mixing unit 348 is included between the separation region 318 and the detection unit 113 and the detection unit 115 and therefore concentration of liquid passed through the separation region 318 can be homogenized and then introduced to the detection unit 323. Therefore, unevenness of sample components in the liquid introduced to the detection unit 323 can be eliminated. Consequently, measurement accuracy at the detection unit 323 can be improved.

As described, by using the chip 251, a sample suitable for optical measurement at the measurement unit 151 can be prepared in the chip 101 to provide for measurement at the measurement unit 151.

In addition, in the chip 251, the separation region 318 may be the same configuration as a separation region of a chip to be described later in a third embodiment.

(Third Embodiment)

This embodiment relates to other configuration of chip applicable to the inspection system 100 (FIG. 1) described in the first embodiment.

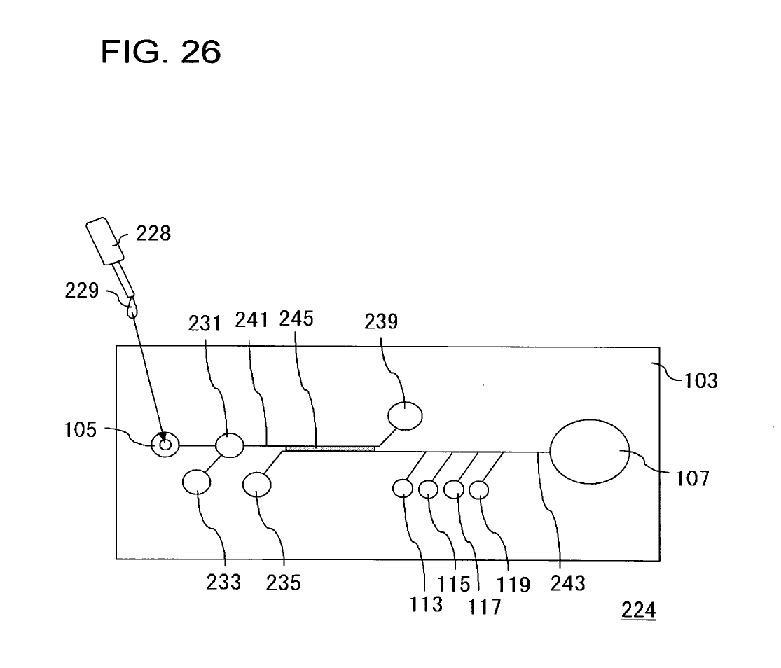

FIG. 26 is a top view showing schematic configuration of a chip 224 according to this embodiment. In the chip 224, the same reference numerals are given to the same constituent elements as in the first and the second embodiments and their description will not be arbitrarily repeated.

The chip 224 is configured so that a first channel 241 communicated to a sample introducing unit 105 communicates to a second channel 243 via a separation region 245. The second channel 243 communicates to a reservoir 107.

The first channel 241 communicates to the sample introducing unit 105 in the upstream thereof and to a reservoir 239 in the downstream thereof. Furthermore, a pretreatment unit 231 is formed in the upstream of the separation region 245 and the pretreatment unit 231 communicates to a channel 233. Dilute solution of the reservoir 239, such as buffer solution or liquid for adjusting liquid of a moving phase is filled in the reservoir 233, and waste solution or the like passed through the first channel 241 is introduced to the reservoir 239.

The second channel 243 communicates to a reservoir 235 in the upstream thereof, to the reservoir 107 in the downstream thereof, and to the detection unit 113 to the detection unit 119 in the downstream of the separation region 245. Dilute solution of the reservoir 239, such as buffer solution or liquid for adjusting liquid of a moving phase is filled in the reservoir 235, and waste solution or the like passed through the second channel 243 is introduced to the reservoir 107.

The user 187 collects body fluid using a sample collecting unit 228 and a sample 229 obtained is introduced to the sample introducing unit 105. The sample collecting unit 228 can be, for example, a dropper and a puncture needle according to a collecting method of body fluid as the sample 229.

In the chip 224, a component to be detected, which is included in the sample 229 introduced to the sample introducing unit 105, is introduced to the sample introducing unit 105, after that, moved in the first channel 241, passed through the pretreatment unit 231, and moved to the second channel 243 via the separation region 245. Then, the component to be detected is introduced to the detection unit 113 to detection unit 119 communicated to the first channel 241 and detected as in the first or the second embodiment.

The pretreatment unit 231 performs pretreatment prior to separating the sample 229 at the separation region 245. The contents of the pretreatment are suitably selected according to the sample 229 and collected accumulation of the component to be detected in the sample 229, for example, the following can be performed:
(i) foreign substances filtration;
(ii) viscosity degradation; and
(iii) pH adjustment.

In the case of the aforementioned pretreatment (i), for example, it may be configured so that porous material is filled in the pretreatment unit 231 and only components with not more than a predetermined size are introduced to the downstream. Furthermore, in the case of the aforementioned pretreatment (ii), it may be such that buffer solution including lysozyme chloride is filled in the reservoir 233 and mixed with the sample 229 at the pretreatment unit 231. Furthermore, in the case of the aforementioned pretreatment (iii), it may be such that buffer solution with a predetermined pH is filled in the reservoir 233 and mixed with the sample 229 at the pretreatment unit 231.

The first channel 241 communicates to the second channel 243 via the separation region 245. The separation region 245 is a separation channel which makes only components with not more than a predetermined size move from the first channel 241 to the second channel 243. Configuration of such separation region 245 will be described later.

In the separation region 245, when the sample 229 passed through the pretreatment unit 231 flows from the first channel 241 and the reservoir 235 filled in the reservoir 235 flows from the second channel 243, components in the sample 229 passed through the separation region 245 from the first channel 241 moves in the second channel 243 toward the reservoir 107 and are introduced to the detection unit 113 to the detection unit 119.

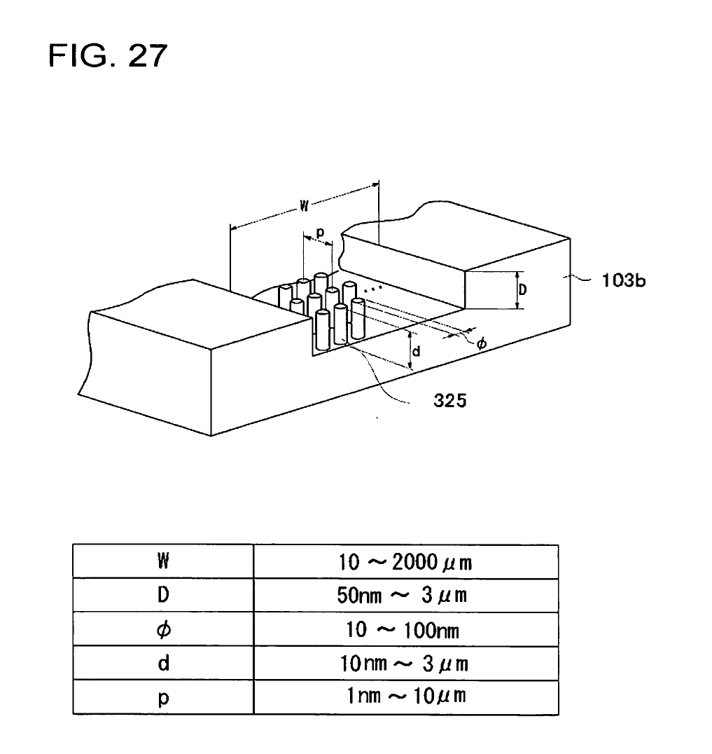

FIG. 27 is a view showing an example of configuration of the separation region 245. In FIG. 27, a groove portion with width W and depth D is formed in the substrate lower portion 103b, cylindrical pillars 325 with diameter p and height d are regularly formed at even intervals. The sample passes through spaces between the pillars 325. Average distance between adjacent pillars 325 is p. Each dimension can be within a range shown in FIG. 27, for example.

In addition, in this specification, “pillar” shows one mode of a columnar body and denotes a minute columnar body having shape of cylinder and cylindroid. Furthermore, “pillar patch” and “patch area” show one mode of a columnar body arrangement unit and denote an area formed with a plurality of pillars in a group.

Manufacturing of the pillars 325 can be performed, for example, by etching the substrate lower portion 103b to be pattern shape, however, its manufacturing method is not particularly limited.

In the case where plastic material is used as the substrate lower portion 103b, the pillars 325 can be formed by known methods suitable for kinds of material of the substrate lower portion 103b, such as etching, press molding using metal molds such as emboss forming or the like, injection molding, formation by optical curing, and the like.

In the case where the substrate lower portion 103b is made up of plastic material, the substrate lower portion 103b formed with the pillars 325 can be formed by injection molding or injection compression molding using a metal mold manufactured by electroforming and inverting a master which is manufactured by machining or etching. Furthermore, the pillars 325 can be formed by press working using a metal mold. Further, the substrate lower portion 103b formed with the pillars 325 can be also formed by a photo molding method using photopolymer resin.

Furthermore, in the case where silicon is used as the substrate lower portion 103b, patterning can be performed using calixarene electron-beam negative resist or Sumi-resist NEB (manufactured by Sumitomo chemical co., LTD), or the like. A separation region 318 can be designed according to an object component by suitably selecting kinds of resist.

According to this chip, a component in body fluid can be separated and therefore detection reaction can be certainly performed at the detection unit 113. Furthermore, accuracy and sensitivity of measurement using the mobile terminal 127 can be improved. Further, the pretreatment unit 231 is provided and therefore separation efficiency and detection sensitivity of the sample 229 can be further improved.

In addition, in the chip 224, the separation region 245 can be the same configuration as the separation region 318 of the chip 251 (FIG. 18) of the second embodiment.

(Fourth Embodiment)

This embodiment relates to measurement of blood sugar level using the inspection system 100 described in the above first embodiment to the third embodiment. The case where the inspection system 100 uses the chip of FIG. 18 as an example will be described below.

Enzyme such as glucose oxidase, mutarotase, peroxidase, and ascorbate oxidase and a coloring reagent such as 4-aminoantipyrine and phenol are attached to the detection unit 323 of the chip 251 as a glucose determination reagent. A measurement wavelength at this time is 505 nm, for example. Furthermore, the separation region 318 is configured so that a low molecular component preferentially passes. Further, the detection unit 323 to which a coloring reagent for obtaining blank data is not applied is provided as the detection unit 323 corresponding to the detection unit 113 of FIG. 3.

The user 187 punctures a finger using a conventionally used puncture device, the sample collecting unit 228 (FIG. 26) in the third embodiment, or the like, and introduces to the sample introducing unit 105 on the chip 251. When the detection unit 323 is colored, measurement and transmission of measurement value are performed in accordance with the aforementioned procedure with reference to FIG. 17. In this embodiment, a measurement object selected in step 112 is set as a blood sugar level. By doing so, the measurement object selection acceptance unit 157 of the analysis center 153 accepts that the measurement object is a blood sugar level. Then, the analysis unit 165 and the estimation processing unit 179 obtains information on measurement of the blood sugar level from the analysis information memory unit 169 and the relevant information memory unit 171 to analyze and estimate.

After estimating at the estimation processing unit 179, additional information corresponding to the result may be transmitted from the transmitting/receiving unit 185 to the mobile terminal 127 together with the estimation result. For example, medical agencies located near user's home may be introduced or medical care acceptance schedule may be transmitted to the user 187 whose blood sugar level is high, and to the user 187 whose blood sugar level is a little high, meal menu or the like for improving that may be transmitted. Furthermore, menu about exercise therapy and list on sports centers can be transmitted.

By using the inspection system of this embodiment, those who concern blood sugar levels or suffer from diabetes can immediately transmit measurement result to an analysis center.

In addition, the measurement object of this embodiment may be urine sugar level in place of blood sugar level.

(Fifth Embodiment)

This embodiment relates to measurement of cholesterol in the blood using the inspection system 100 described in the first embodiment to the third embodiment. The case where the inspection system 100 uses the chip 224 (FIG. 26) which is described in the third embodiment as an example will be described below.

Any three units of the detection unit 113 to the detection unit 119 of the chip 224 attach measuring reagents for measuring LDL, HDL, and total cholesterol in the blood each. The remained one is used for obtaining blank data.

Detection reaction for quantitating such cholesterol can be performed by the enzyme method, for example. When the detection unit 115 is colored, measurement and transmission of measurement value are performed in accordance with the same procedure as the third embodiment. In this embodiment, cholesterol in the blood is set as the measurement object selected in step 112.

By using the inspection system according to this embodiment, the user 187 who concerns cholesterol value or needs course observation can comprehend user's own value of cholesterol in the blood without periodically visiting medical agencies.

(Sixth Embodiment)

This embodiment relates to determination of blood group using the inspection system 100 described in the first embodiment to the third embodiment. Description will be made below with reference to the chip 101 (FIG. 3) described in the first embodiment, the chip 251 (FIG. 18) described in the second embodiment, and the chip (FIG. 26) described in the third embodiment.

First, the case which performs “Cell typing” of ABO blood group using the chip 101 of FIG. 3 will be described. “Cell typing” is inspection to detect an antigen in a blood sample.

One each kind of freeze-dried anti-A serum and anti-B serum are set to two detection unit 113 and detection unit 115 each. When a blood sample is introduced to the sample introducing unit 105, filled in the detection unit 113 and the detection unit 115 are filled with the blood sample and preliminarily set anti-A serum and anti-B serum are dissolved in the process that the blood sample proceeds in the channel 109 toward the reservoir 107 by capillary attraction.

In the case where the dissolved anti-A serum and anti-B serum are mixed with the blood sample by diffusion or the like and there exist a blood cell antigen (A antigen or B antigen) to each antiserum in the blood sample, a red blood cell is aggregated and precipitated. When the red blood cell is aggregated and precipitated, the amount of light passing through the detection unit 113 and the detection unit 115 increases, thereby enabling to detect optically.

It is determined to be AB group blood when the detection unit 113 set with anti-A serum and the detection unit 115 set with anti-B serum are both aggregated, to be A group blood when only the detection unit 113 set with anti-A serum is aggregated, to be B group blood when only the detection unit 115 set with anti-B serum is aggregated, and to be O group blood when neither are aggregated.

In order to further prevent a measurement mistake, a plurality of channel groups on the chip 101 are provided on the same chip as comparison, a blood sample is introduced to one side, to the other side, suspension of latex beads coated with an A group antigen or a B group antigen on the surface in place of the blood sample is introduced, and erroneous decision can be prevented by certainly generating agglutination at the beads side.

Next, the case where “Reverse typing” of ABO blood group is performed using the chip 251 of FIG. 18 will be described. The “Reverse typing” is inspection to detect an antibody in a blood sample.

Suspension of latex beads coated with an A group antigen, suspension of latex beads coated with a B group antigen, and suspension of latex beads coated with an O antigen are set to at least three provided detection units 323 each. At that time, it may be configured that the amount of suspension is set to approximately one-half the entire capacity of the detection unit 323 to allow mixture with a sample, in order not to reverse the suspension to the channel 109, a liquid switch is provided in the dispensing channel 114 and a trigger channel for releasing the liquid switch is branched from the channel 109 in the upstream. Configuration of the liquid switch is the before described configuration with reference to FIG. 23, for example.

When the blood sample is introduced to the inlet 106, the blood sample proceeds in the channel 330 by capillary effect, however, as described effects with reference to FIG. 32(A) and FIG. 32(B) in the second embodiment, the blood sample reaches the waste solution reservoir 319 without flowing into the channel 109 on the opposite side. Next, extracting buffer, for example, phosphate buffered saline (referred to as PBS) is introduced to the buffer inlet 320, the fine channels 329 open, however, the maximum width of the fine channels 329 are made to be smaller (for example, 1.8 μm) than the minimum size of the red blood cell, whereby a blood cell remains in the channel 330 and only a plasma component is extracted to the channel 109. After the extracted plasma component becomes constant concentration in the mixing unit 348, the plasma fills the detection unit 323 via the dispensing channel 114 while proceeding in the channel 109 toward the reservoir 107 and is mixed with latex beads suspension preliminarily set in the detection unit 323. In the case where there exists an antibody in the extracted plasma, an antigen against the antibody makes the coated latex beads aggregate and precipitate and therefore the presence of an antibody can be detected based on the increase of light transmittance as in the case of the aforementioned blood cell.

A group blood includes an anti-B antibody, B group blood includes an anti-A antibody, O group blood includes both anti-A antibody and anti-B antibody, and AB group blood does not include both antibodies. Therefore, it can be determined that it is to be AB group blood when all the detection units 323 do not aggregate, to be B group blood when only the detection unit 323 set with A group antigen latex beads suspension aggregates, to be A group blood when only the detection unit 323 set with B group antigen latex beads suspension aggregates, to be O group blood when both A group antigen latex beads suspension and B group antigen latex beads suspension aggregates.

Next, the case where a first determination of leukocyte type (HLA type) is performed using the chip 224 of FIG. 26 will be described. The blood cell group includes 4 types of A, B, C, D and each type has a plurality of sub-type. The first determination is a determination method using phenomena in which a white blood cell in a blood sample is aggregated or destroyed in response to antiserum to each antigen type.

First, antiserum to each HAL group and sub type, or a freeze-dried rabbit complement is set to the detection unit 113 or the like of the chip 224. Four detection units including the detection unit 113, the detection unit 115, the detection unit 117, and the detection unit 119 are provided in the chip 224 of FIG. 26, however, since there exist more HAL group than those of detection units, the following will be described as if the number of the detection units are sufficiently provided by suitably adding and including for sub type.

The separation region 245 of the chip 224 is used, whereby blood cells in the blood sample can be extracted by dividing them according to the size order. In the case of the separation region 245 in which pillars are patchy arranged, a white blood cell which is the largest in the blood cell is first separated to be extracted, and by using this, only white blood cell in the blood sample is introduced to the detection unit.

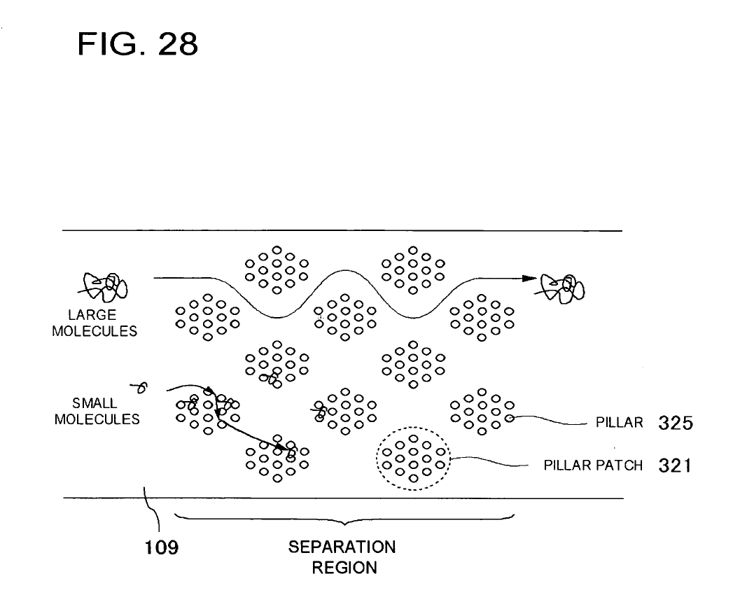

A specific structure of the separation region 245 can be a pillar patch structure type in which a large size component as shown in FIG. 28 can be passed rapid1y. The separation region 245, in FIG. 28, has structure in which the first channel 241 disposed on the left side communicates with the second channel 243 disposed on the right side. A path width between adjacent pillar patches 321 is larger than a gap between pillars 325 in the pillar patch 321. Since this embodiment separates the blood cell, the gap between the pillars 325 is set to, for example, approximately 100 nm to 1000 nm, and the path width is set to preferably 2 to 20 times as wide as the gap of the pillars 325, more preferably approximately 5 to 10 times. In FIG. 28, time difference in the flow of white blood cell, red blood cell, and blood platelet can be increased by elonging length of the pillar patch portion.

Getting back to FIG. 26, processing procedure will be described. First, a blood sample is introduced to the sample introducing unit 105 and mixed with a buffer(PBS, for example) held in reservoir 233 at the pretreatment unit 231 to dilute to approximately 2 to 10 times, then the diluted sample is supplied to the separation region 245 via the first channel 241. At that time, timing at which the buffer is introduced from the reservoir 233 to the pretreatment unit 231 and timing at which the sample is introduced from the pretreatment unit 231 to the first channel 241 can be optimally selected by using the aforementioned liquid switch and the channel expanded region. Specifically, it may be configured that the liquid switches are provided on the channel connecting the reservoir 233 and the pretreatment unit 231 and on the portion of pretreatment unit 231 side (upstream side) of the first channel 241, and a trigger channel to those liquid switches is supplied from the sample introducing unit 105 via the channel expanded region so as to generate appropriate delay time.

When the diluted blood sample passes through from the first channel 241 to the separation region 245 and appears in the second channel 243 side, a white blood cell which is maximum in size appears first, a red blood cell behind, and a blood platelet last. When the buffer is supplied from the reservoir 235 to the second channel 243 at a stage where only the white blood cell appears in the second channel 243 by using time difference in the flow between the white blood cell and the red blood cell, the buffer flows in the second channel 243 toward the reservoir 107 with being mixed with only the white blood cell and, on the way, is dispensed to a plurality of detection units including the detection unit 113. Timing at which the buffer is introduced from the reservoir 235 can be realized by configuration in which the liquid switch is provided in the channel connecting the reservoir 235 and the separation region 245 and its trigger channel is supplied from the first channel 241 via the channel expanded region having the optimum delay time corresponding to separation speed of the blood cell.

Mixed liquid of the white blood cell and the buffer dispensed at the detection unit dissolves antiserum set at the detection unit to react with it. It can be detected based on the increase of light transmittance of the detection unit with the agglutination that a type if antigen to the antiserum set at the detection unit is possessed in the case where the white blood cell agglutinates. Furthermore, not only an antiserum but also the presence of an antigen can be detected by optically detect the detection unit brought transparency when a white blood cell is ruptured and dissolved in the case where a rabbit complement is set at the same time.

In doing as described above, detection reaction necessary for blood grouping of the blood sample can be conveniently and certainly performed and optical characteristics of the detection unit of the chip can be measured using the measurement unit 151 of the mobile terminal 127.

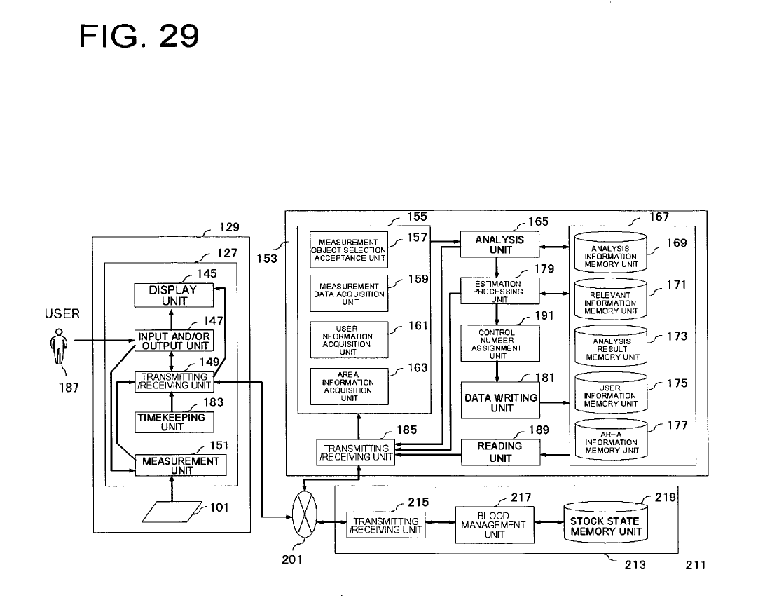

Next, an inspection system using the above described blood grouping chip will be described. FIG. 29 is a view showing configuration of an inspection system using the blood grouping chip. In an inspection system 211 of FIG. 29, the same reference numerals are given to the same constituent elements as in the inspection system 100 (FIG. 12) and their description will not be arbitrarily repeated.

The inspection system 211 further includes a medical agency 213 in addition to the measuring device 129 and the analysis center 153. The medical agency 213 includes a transmitting/receiving unit 215, a blood management unit 217, and a stock state memory unit 219. Further, the medical agency 213 and the analysis center 153 are connected via the network 201.

The transmitting/receiving unit 215 communicates with the analysis center 153 via the network 201 and communicates with the mobile terminal 127 of the user 187.

The blood management unit 217 controls information on blood transfusion at the medical agency 213. A stock state of blood capable of transfusing blood to the user 187 is read out from the stock state memory unit 219 based on information on blood group of the user 187 estimated by the estimation processing unit 179. The read out information is transmitted to the mobile terminal 127. Furthermore, via the network 201, procurement of blood transfusion may be performed from other medical agencies (not shown in the drawing) and preparation for getting the user 187 may be performed.

By adopting such configuration, when the user 187 is visited by large accident and injury and the like and needs to be carried to the medical agency 213 by ambulance vehicle (not shown in the drawing), it is possible to carry the user to the optimum medical agencies.

In addition, a user 187 of the mobile terminal 127 may be an injured person or emergency staff who comes to the person to assist. In the case where the user 187 is an injured person, the user himself/herself performs measurement if the user 187 himself/herself can measure, and emergency staff performs measurement if it is difficult for the user to perform measurement. Even in a state where an injured person cannot identify himself/herself, for instance, the injured person is unconscious, it is possible to clear his/her identity using user ID of the mobile terminal 127 and to inform his/her family by using the mobile terminal 127 of the user 187.

Furthermore, in the case where an injured person has not the mobile terminal 127, blood group of the injured person can be determined by performing measurement of blood at the injured portion, using the mobile terminal 127 and a chip 193 which emergency staff has.

Furthermore, in this embodiment, estimation result at the estimation processing unit 179 is transmitted to the medical agency 213 and a stock state of compatible blood is transmitted to the mobile terminal 127 by the medical agency 213 which received the estimation result, whereby emergency staff can select the optimum medical agency 213 and promptly carry the user 187.

In addition, the inspection system 211 of FIG. 29 is applicable not only to this embodiment but also to other embodiment and the chip configuration applied to the inspection system 211 can also be arbitrarily selected to any of above-mentioned embodiments.

(Seventh Embodiment)

This embodiment relates to determination of stress level using inspection system described in the first to the third embodiments.

Determination of stress level can be performed by detecting catecholamine concentration in saliva. For example, luminol type chemiluminescence reagent can be used for catecholamine detection.

In this embodiment, the estimation processing unit 179 determines stress level of the user 187 and calls the user 187 attention in the case of low stress level.

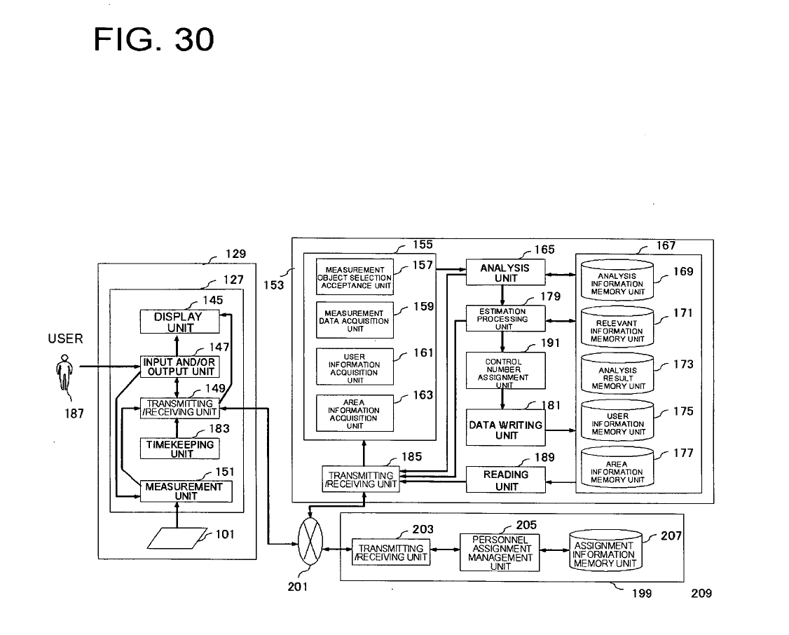

Further, FIG. 30 is a view showing different configuration of inspection system according to this embodiment. In an inspection system 209 of FIG. 30, the same reference numerals are given to the same constituent elements as in the inspection system 100 (FIG. 1) and their description will not be arbitrarily repeated.

The inspection system 209 further includes a management company 199 in addition to the measuring device 129 and the analysis center 153. The management company 199 manages personnel assignment of the user 187 engaging affairs important for maintaining stress level of operators, for example, a nuclear power plant, a metalliferous mine, a coal mine, monitoring service and the like. The management company 199 includes a transmitting/receiving unit 203, a personnel assignment management unit 205, an assignment information memory unit 207. The management company 199 and the analysis center 153 are connected via a network 201.

The transmitting/receiving unit 203 communicates with the analysis center 153 via the network 201 and communicates with the mobile terminal 127 of the user 187.

The personnel assignment management unit 205 manages an operation schedule of the user 187. Changes and the like of personnel assignment of the user 187 are performed based on estimation result of the estimation processing unit 179. At that time, information on personnel assignment stored in the assignment information memory unit 207 is referred, and when changing this, new assignment is stored in the assignment information memory unit 207.

Furthermore, change of personnel assignment set at the personnel assignment management unit 205 is transmitted from the transmitting/receiving unit 203 to the mobile terminal 127 of the user 187 to present in display unit 145. When substitution personnel is dispatched to a working site, personnel capable of changing off is dispatched based on area information of an operator to be changed off, stored at the user information memory unit 175 and the area information memory unit 177.

Such configuration enables personnel assignment to be optimized at affairs important for maintaining stress level of operators. Therefore, working safety can be appropriately maintained.

In addition, the inspection system 209 of FIG. 30 is applicable not only to this embodiment but also to other embodiments and the chip configuration applied to the inspection system 209 can also be arbitrarily selected to any above-mentioned embodiments.

(Eighth Embodiment)

This embodiment relates to different configuration of the chip applicable to the inspection system 100 (FIG. 1) described in the first embodiment. The chip described in this embodiment is configuration to neutralize the chip after performing measurement at the mobile terminal 127.

An infectious source such as bacteria derived from a sample and poisonous substance such as strong acid or a cyanogen compound derived from a measuring reagent may be held inside the chip used for measurement. In such case, if the chip after use is neutralized and detoxified if need, occurrence possibility of health damages can be further certainly avoided, chip can be carried more safely, and can be disposed safely. Specifically, for example, it is configured that an infectious source and poisonous substance held in the chip are neutralized by filling neutralization liquid in the channel of the chip after measurement.

As neutralization liquid, for example, to bacteria, neutral detergent and dilute aqueous solution of sodium hypochlorite may be included. Furthermore, to strong acid, alkaline aqueous solution or the like of aqueous sodium hydroxide or the like may be included. Further, to a cyanogen compound, alkaline sodium hypochlorite aqueous solution (pH 8 to 9) or the like which oxidizes and dissolves a cyanogen compound may be included. Particularly, alkaline sodium hypochlorite aqueous solution including a small amount of an interfacial active agent is effective for both infectious source, acid, and cyanogen and therefore it can be preferably used.

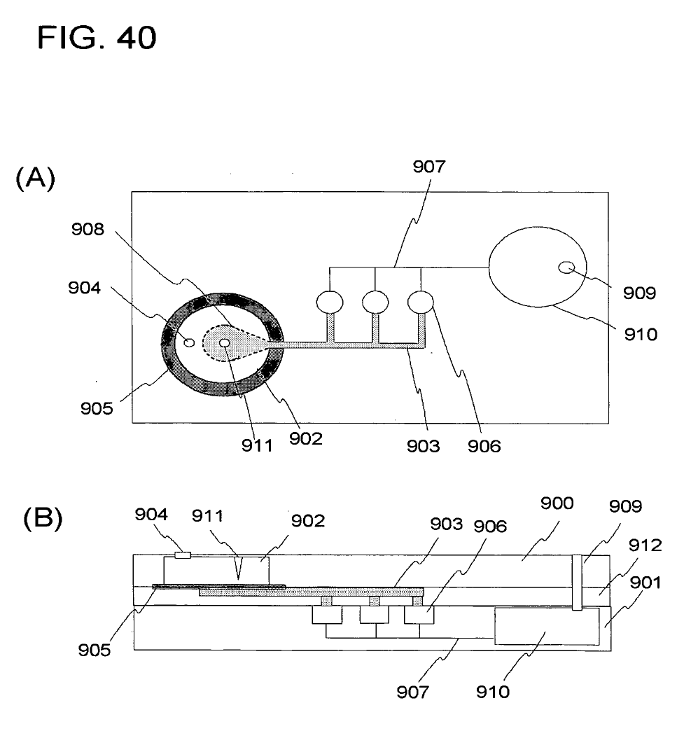

FIG. 40(A) is a plan view showing configuration of a chip including a neutralizing mechanism. Furthermore, FIG. 40(B) is a cross-sectional view of FIG. 40(A). The chip shown in FIG. 40(A) and FIG. 40(B) is made up by bonding a chip upper substrate 900 having a neutralization reservoir 902, a barrier membrane 905, an air hole 904, a needle 911 and an air hole 909, a chip midd1e substrate 912 having a neutralization liquid channel 903 and the air hole 909, and a chip lower substrate 901 having an analytical channel system such as a detection cell 906 and a detection channel 907, and a waste solution reservoir 910. The air hole 909 penetrates the chip upper substrate 900 and the chip midd1e substrate 912 and communicates to the waste solution reservoir 910. The chip shown in FIG. 40(A) and FIG. 40(B) form the chip upper substrate 900, the chip midd1e substrate 912, and the chip lower substrate 901, respectively, and they are obtained by bonding together.

The barrier membrane 905 is placed between the chip upper substrate 900 and the chip midd1e substrate 912 to separate the neutralization reservoir 902 from the neutralization liquid channel 903. The neutralization reservoir 902 has a thin upper surface which is configured so as to deform when a user pushes the upper surface of the neutralization reservoir 902 from the chip upper substrate 900 side. The needle 911 fixed to the upper surface punctures the barrier membrane 905 by the deformation of the upper surface of the neutralization reservoir 902 to make a hole in the barrier membrane 905.

The neutralization liquid channel 903 communicates at least one portion of the analytical channel system such as the detection cell 906 and the detection channel 907. One end of the neutralization liquid channel 903 is, a diameter expansion portion 908 which expands in diameter under the barrier membrane 905. The needle 911 is located above the diameter expansion portion 908. The detection channel 907 communicates to the waste solution reservoir 910. The aforementioned neutralization liquid is accommodated in the neutralization reservoir 902 and its liquid level is maintained at a position higher than the upper surface of the analytical channel system and the waste solution reservoir 910.

When neutralization is performed in the chip, a user opens the air hole 904 and the air hole 909 which are sealed before use and pushes the needle 911 from the upper surface of the neutralization reservoir 902 toward the barrier membrane 905 to make a hole at one portion of the barrier membrane 905. Then, the neutralization liquid flows into the neutralization liquid channel 903 by capillary effect and water-level difference and fills the analytical channel system including the detection cell 906 and the detection channel 907 via the neutralization liquid channel 903. As a result, an infectious source and poisonous liquid remained in the analytical channel are swept toward the waste solution reservoir 910 to be neutralized in the waste solution reservoir 910. This configuration enables the chip after measurement to be conveniently neutralized. The neutralization enables the channel system of the chip to be conveniently disinfected and detoxified.

Furthermore, in the aforementioned configuration, a user possibly forgets to neutralize. In order to avoid this anxiety, configuration of the mobile terminal side may be devised so that the upper surface of the neutralization reservoir 902 has to be pushed when the chip is removed after measurement.

For example, the chip having the neutralization reservoir 902 shown in FIG. 40(A) and FIG. 40(B) and the mobile terminal may have a mechanism in which the removal of chip of post measurement from the mobile terminal is a trigger for the introduction of the neutralization liquid held in the neutralization reservoir 902 to the detection channel 907 and the detection cell 906 via the neutralization liquid channel 903.

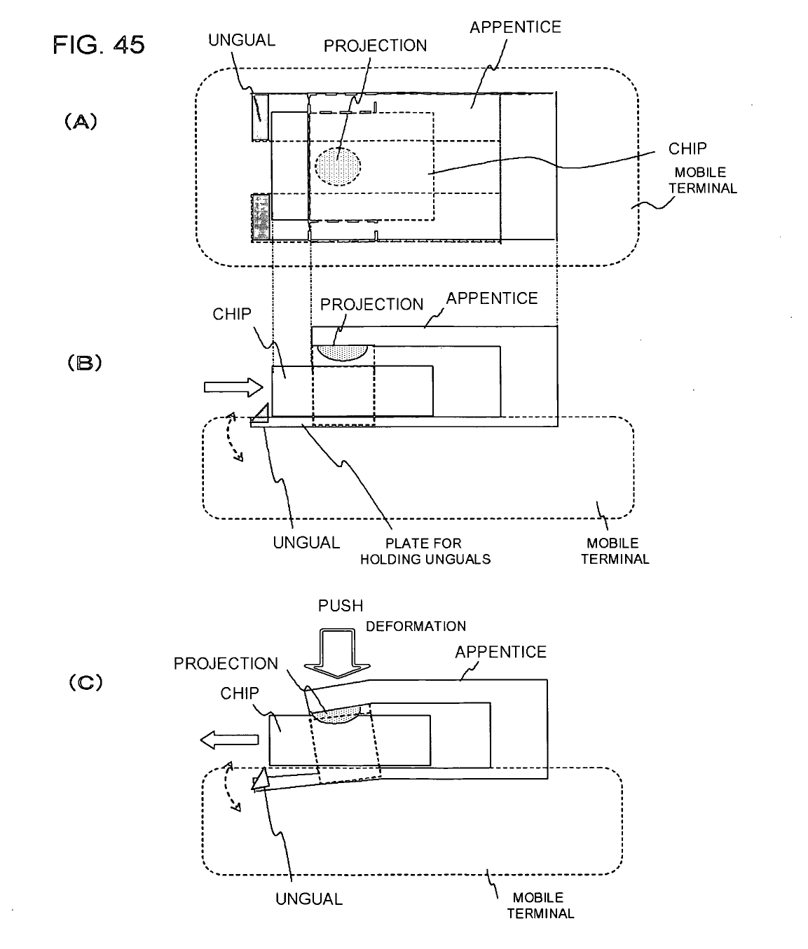

Specifically, movable unguals for holding the chip from the bottom side so that the chip cannot be removed and an “appentice” portion for covering over at least the upper surface portion of the neutralization reservoir 902 of the chip are provided in the portion where the chip is attached to the a mobile terminal. FIG. 45(A) to FIG. 45(C) are views showing configuration of the thus configured mobile terminal and configuration of the chip. FIG. 45(A) is a cross-sectional view exemplifying configuration in which the “appentice” portion is provided on the back surface of the mobile terminal, and FIG. 45(B) and FIG. 45(C) are cross-sectional views. The back surface of the mobile terminal can be a back surface of the surface where the feature button group 143 of the mobile terminal shown in FIG. 4 is provided. Referring to FIG. 40(A), FIG. 45(A), and FIG. 45(A) to FIG. 45(C), the “appentice” portion is jointed by a plate for holding the unguals and the side surfaces (FIG. 45(B)). The “appentice” portion and the plate for holding the unguals are made up of elastically deformable resin or metal and it is configured that when the “appentice” portion is pushed down, the plate for holding the unguals is deformed at the same time so that the unguals are accommodated inside the mobile terminal (FIG. 45(C)).

A projection having a curved surface is provided at a position corresponding to the upper surface of the neutralization reservoir 902 of the chip of the “appentice” portion, and when the “appentice” portion is pushed down, the projection pushes the upper surface of the neutralization reservoir 902 to deform. At this time, the needle 911 is pressed to the barrier membrane 905 to make a hole in the barrier membrane 905. Although the projection sandwiches the chip, the chip can be removed even in a state where the unguals are being pushed down because the projection has a smooth shape like a portion of sphere. By the aforementioned configuration, it can be configured that when a user remove the chip, the “appentice” portion is pushed down and the upper surface of the neutralization reservoir 902 which is placed thereunder has to be pressed.

In addition, it can be configured that a trigger channel is branched from the diameter expansion portion 908 and this trigger channel is connected at a predetermined position of the neutralization liquid channel 903 via the liquid switch. This can suppress liquid from reversely flowing toward the neutralization liquid channel 903 from the detection cell 906.

Furthermore, in this embodiment, after a desired channel system is configured in the chip upper substrate 900 and the chip lower substrate 901 which are made of resin material such as PMMA, the chip having the nuetralizing mechanism can be manufactured by bonding these substrates, but, the chip configuration is not limited to such configuration having the chip upper substrate 900 and the chip lower substrate 901. Furthermore, when neutralization liquid is sent from the neutralization reservoir 902 to the waste reservoir 910, capillary effect and water-level difference is used, however, gas having a pressure higher than atmospheric pressure is preliminarily held in the neutralization reservoir 902 without providing the air hole 904, the neutralization liquid can be sent using the pressure. Furthermore, the neutralization liquid can be sent using an external liquid sending unit.

Furthermore, the aforementioned detection method using FIG. 9 is applied to the detection channel 907 of the chip shown in FIG. 40(A) and FIG. 40(B) and the dispensation region of the detection channel 907 communicated to each detection cell 906 can be used as the detection unit 113 or the detection unit 115 in FIG. 9.

(Ninth Embodiment)

This embodiment relates to different configuration of the measuring device 129 applicable to the inspection system 100 (FIG. 1) described in the first embodiment. In an analysis chip, in the case where concentration of a predetermined substance is measured based on absorption of light or scattering, an optical path passing through a sample need to have appropriate length and therefore there is a method to measure by transmitting light in an extending direction of the channel in the case of analyzing a small amount of sample. In this case, even the sample is extremely small in amount, a cross-sectional area of the channel is small and therefore a large optical path length having approximately 5 mm to 1 cm can be secured. However, width of the channel section is small, approximately several hundreds of pm to several tens of μm, accurate positioning is required to certainly enters irradiating light to the channel and certainly introduces transmitted light from the opposite side of the channel to the light receiving unit. Therefore, there further leaves room for improvement in reduction of measurement time and in improvement of measurement data reproducibility.

The measuring device of this embodiment can be appropriately used in such a case. In this embodiment, a concave portion is provided on the side surface facing to the chip and two convex portions engaging with the concave portion of the chip are provided in the chip insertion portion of the mobile terminal. A portion of the mobile terminal for attaching the chip is processed in convex-concave shape where corresponds in shape, whereby positioning can be further conveniently performed. Furthermore, light from a light source is introduced to one side of two convex portions of the mobile terminal and a light receiving unit or a waveguide to a light receiving unit is provided on the other side. Then, a channel for detecting the chip is formed so that the light source and the light receiving unit are disposed opposite to each other via the channel for detecting the chip. Thereby, optical path length in measuring can be further increased and measurement can be stably performed.

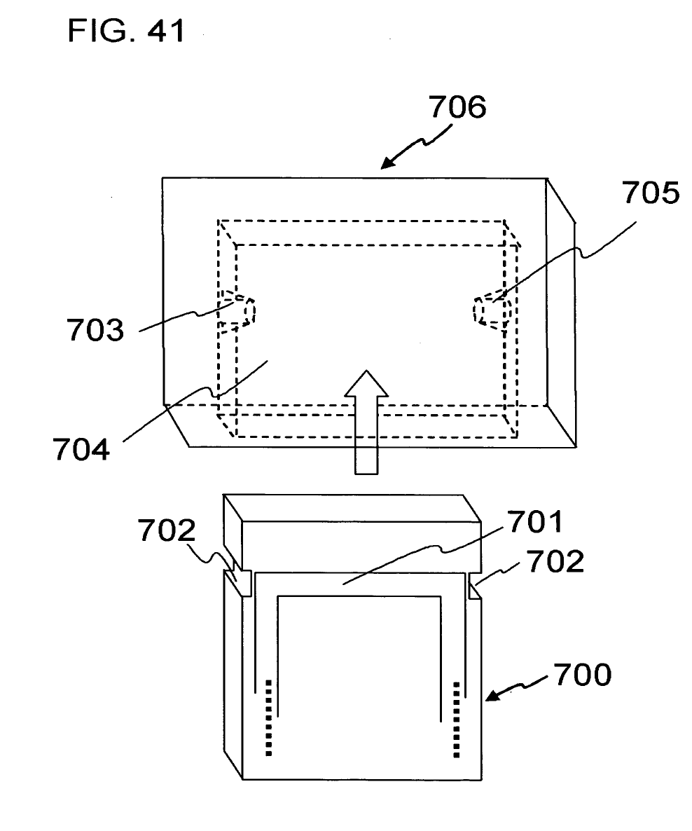

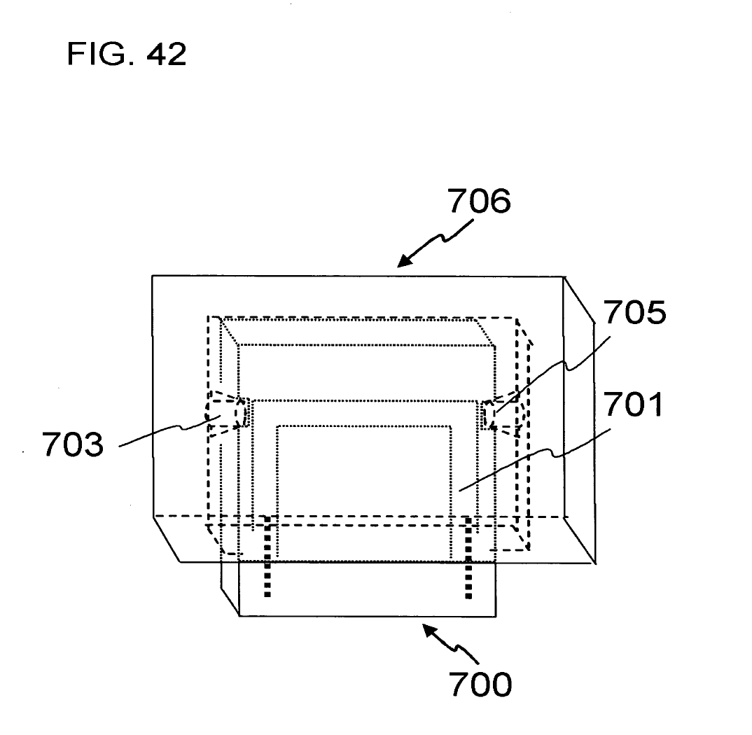

FIG. 41 and FIG. 42 are perspective views showing a measuring device according to this embodiment. The measuring device shown in FIG. 41 and FIG. 42 is composed of a chip 700 and a mobile terminal 706. FIG. 41 shows a state before the chip 700 is inserted into a predetermined position of the mobile terminal 706, and FIG. 42 shows a state where the chip 700 is inserted in the mobile terminal 706. In addition, FIG. 41 and FIG. 42 show a region in which the chip 700 of mobile terminal 706 is attached and in the vicinity thereof, however, for example, the configuration of the mobile terminal 127 described in the above embodiment can be applied to the mobile terminal 706.

The chip 700 has a channel 701 bent in a rectangular shape and a straight portion of the channel 701 is connected to a cutout portion 702 via a sufficiently thin, transparent partition wall. Furthermore, the mobile terminal 706 has a concave attachment unit 704. When the chip 700 is attached to the mobile terminal 706, an irradiation unit 703 provided in the attachment unit 704 and a light receiving unit 705 are fitted into the cutout portions 702, and by these engagement, the chip 700 is engaged and fixed to the mobile terminal 706.

The irradiation unit 703 and the light receiving unit 705 are fixed opposite to the attachment unit 704 via an elastic member such as springs and are slidable in an axis direction. The irradiation unit 703 is a leading edge of an optical fiber which leads measurement light to the chip 700 from the inside of the mobile terminal 706 or a light source such as LED which is covered with a less abrasive material such as resin and processed in substantially truncated cone-shaped. The measurement light is irradiated to the channel 701 of the chip 700 from the leading edge of the irradiation unit 703. The light receiving unit 705 is a leading edge of an optical fiber which leads light from the channel 701 to the measurement unit of the mobile terminal 706 or a photodiode which is covered with a less abrasive material such as resin and processed in substantially trapezoid shaped, and light passed through the channel 701 along the extending direction of the channel 701 is emitted to the leading edge of the light receiving unit 705.

As shown in FIG. 41, when the chip 700 is pushed into the attachment unit 704 from a direction of an arrow in the drawing, the irradiation unit 703 and the light receiving unit 705 are compressed by the side surfaces of the chip 700 to be temporarily pushed from the attachment unit 704 side toward the inside of the mobile terminal 706, however, when the cutout portions 702 of the chip 700 reach, the irradiation unit 703 and the light receiving unit 705 are ejected by the elastic members to fit in the cutout portions 702, as shown in FIG. 42. After measuring in this state, the chip 700 is pulled in a reverse direction of the arrow mark in FIG. 41, the irradiation unit 703 and the light receiving unit 705 are compressed by the side walls of the cutout portion 702 to be pushed again to the inside of the mobile terminal 706, whereby the chip 700 can be pulled out from the mobile terminal 706.

Positioning between the chip 700 and the mobile terminal 706 can be further certainly performed in a short time by using the measuring device of the configuration shown in FIG. 41 and FIG. 42. Therefore, measurement time can be reduced. Furthermore, reproducibility of measurement data can be improved.

(Tenth Embodiment)

This embodiment relates to another configuration of the measuring device 129 applicable to the inspection system 100 (FIG. 1) described in the first embodiment. In the measuring device of this embodiment, a chip has a channel shaped detection unit and length of a detection unit of the chip can be measured in a mobile terminal.

In the case of having a detection unit in which a discoloration portion becomes long according to concentration as a gas detection pipe, length of the discoloration portion can be read visually, but there is concern about variation in reading depending on the person. According to the measuring device of the present invention, since an optical mechanism for measuring length is provided in the mobile terminal, variation of measurement result can be reduced in such a case.

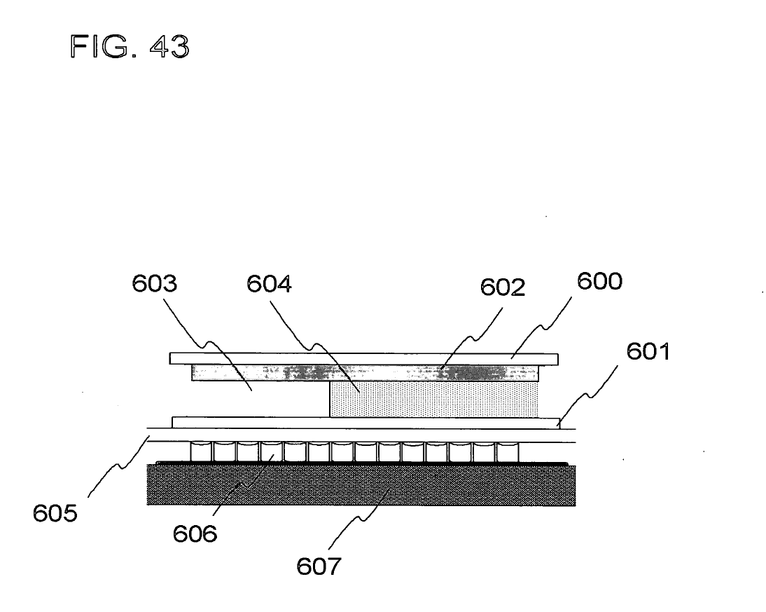

FIG. 43 is a cross-sectional view showing a mechanism for measuring length of a discoloration portion. In a measuring device shown in FIG. 43, the mobile terminal includes a substrate 607, a light receiving element 606 such as a photodiode disposed on the substrate 607 along a channel of a chip in inserting the chip, and a contact portion 605 made of a transparent, less abrasive material such as crystal glass disposed directly on the light receiving element 606. Furthermore, configuration of other members of the mobile terminal can be the configuration of the mobile terminal 127 described in the above embodiments.

Furthermore, in the measuring device shown in FIG. 43, the chip includes a chip lid 600, a chip bottom plate 601, an optical waveguide 602, and an analytical channel 603. At least the chip bottom plate 601 and the analytical channel 603 are made of, for example, transparent resin such as PMMA and transparent material such as glass. Furthermore, colored contents 604 flow in one portion of the analytical channel 603.

In measuring, in a state where the colored contents 604 are present in the analytical channel 603, the chip puts into contact with the contact portion 605 of the mobile terminal in a position relationship shown in the drawing. When light is irradiated to the optical waveguide 602, light leaked out from the optical waveguide 602 illuminates the analytical channel 603 in the whole. This illumination transmits the contents of the analytical channel 603 to reach the light receiving element 606. At this time, since a plurality of the light receiving elements 606 are disposed in a line along the extending direction of the analytical channel 603, only an small amount of light reach the light receiving elements 606 placed just beneath a region where the colored contents 604 are present, compared to the light receiving elements 606 placed just beneath a region except where the colored contents 604 are present.

Numbers are sequentially given to the light receiving elements 606 disposed in a line, and difference of this amount of light is monitored to the longitudinal direction of the analytical channel 603, whereby length of the colored contents 604 can be quantitated as a number of light receiving elements which receive only a sufficient amount of light. Therefore, predetermined components in a sample can be quantitated as the length of the colored contents 604, whereby variation in measurement result depending on the person can be prevented.

(Eleventh Embodiment)

In the inspection system described in the embodiment, the mobile terminal 127 can be configured to further include a detachable sensor. The case where the mobile terminal 127 is a mobile phone as an example will be described.

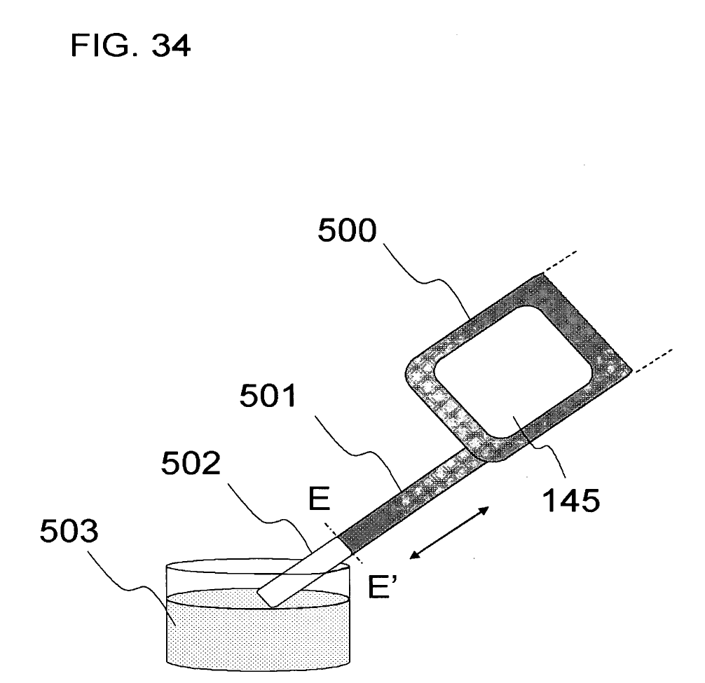

FIG. 34 is a view showing configuration of a mobile terminal with a detachable sensor according to this embodiment. The mobile terminal shown in FIG. 34 includes a main body 500, a rod 501 protruded from the main body 500, and a sensor unit 502 provided at a leading edge portion of the rod 501. The sensor unit 502 is immersed in a sample, thereby allowing predetermined components in the sample to be measured or detected. For, example, in the case where body fluid such as urine is held in a test tube, a beaker, or the like as the sample, the mobile terminal is configured in such shape, thereby allowing measurement to be conveniently performed. A fundamental configuration of the main body 500 can be configuration of the mobile terminal 127 in the aforementioned first embodiment, for example.

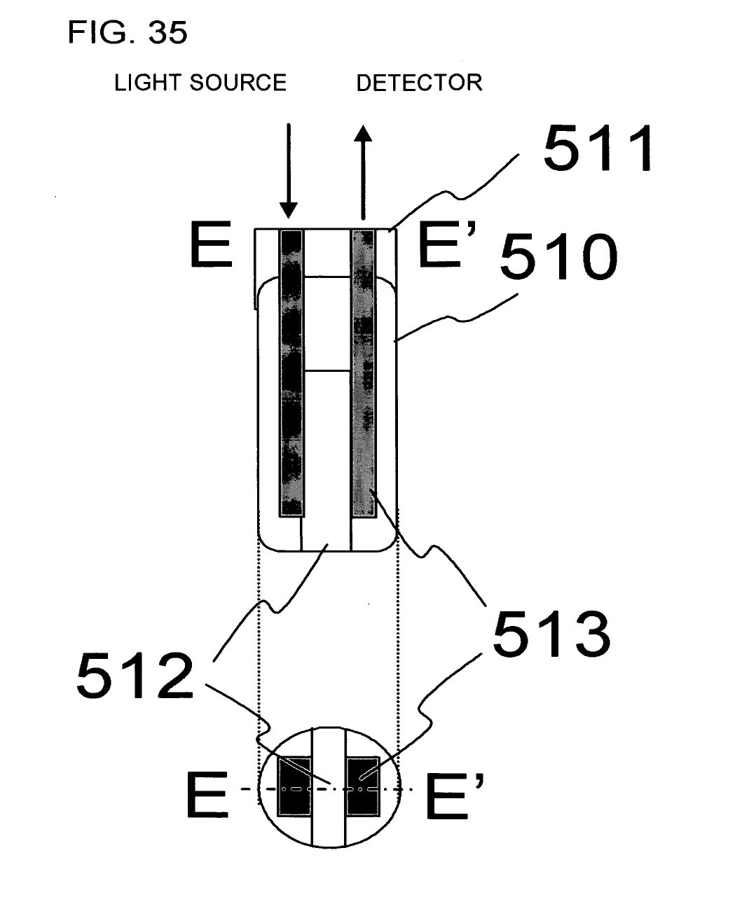

The sensor unit 502 is connected to a measuring device inside the mobile terminal attached at the leading edge portion of the rod 501. The sensor unit 502 is an electrochemical sensor which measures ion concentration or glucose concentration, or an optical sensor using optical fiber such as configuration to be described later with reference to FIG. 35. In the case of the electrochemical sensor, the sensor unit 502 is connected to the measuring device inside the mobile terminal via an electrode.

In the case of the optical sensor, the sensor unit 502 is connected to the mobile terminal 127 via an optical connector. FIG. 35 is a view showing an example of configuration of a detachable optical sensor. In addition, the direction of E-E′ shown in FIG. 35 corresponds to the direction of E-E′ shown in FIG. 34. The optical sensor includes an outer cylinder 510 which holds a plurality of optical fiber cores 513, a capillary cell 512 provided at a leading edge of the outer cylinder 510, and an optical connector 511 in which light from the optical fiber core is connected to an optical system in the rod 501. The optical system of the rod 501 includes a light source and a light receiving unit.

Material of the outer cylinder 510 is made of cladding material so as to substantially perform total reflection to the optical fiber core 513. When the leading edge of the sensor unit 502 is immersed in a sample, the sample goes into the capillary cell 512 by capillary effect. Light from the light source via one of a pair of optical fiber cores 513 provided opposite to the side end portions of the rod 501 of the capillary cell 512 is irradiated, and the light is measured via the other, whereby absorption of light or scattering of the sample entered into the capillary cell 512 can be measured.

In addition, in FIG. 34 and FIG. 35, in view of deterioration with time and weather of the sensor unit, it is preferable that the sensor unit 502 is detachable configuration to the rod 501, however, it may be a fixed type. Furthermore, it may be configured that the rod 501 is pulled into the mobile terminal when being carried and pulled out in using for measurement. In doing so, the entire of the mobile terminal when being carried can be reduced in size, the rod 501 is not obstacle when being carried, and convenience can be improved.

Furthermore, in this embodiment, it can be configuration capable of cleaning a portion only where a sample is adhered. For example, the mobile terminal shown in FIG. 34 or FIG. 35 can provide a sensor unit 502 including a cleaning mechanism. The cleaning mechanism is provided, whereby a sensor unit 502 which is in many cases, contaminated with a sample can be cleaned before measurement or after measurement and therefore accurate measurement data can be further obtained. Furthermore, the mobile terminal can be more sanitary mobile and can be carried.

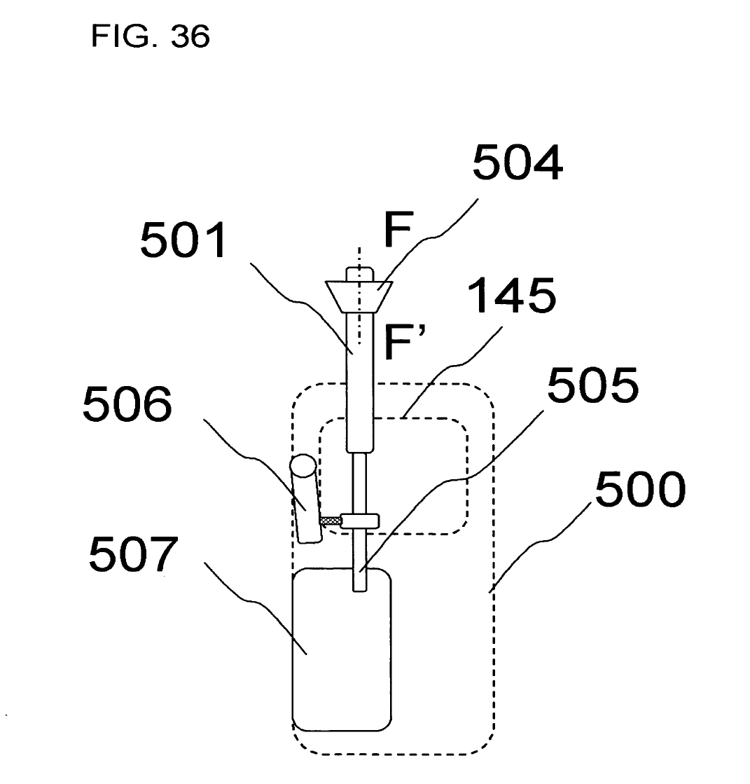

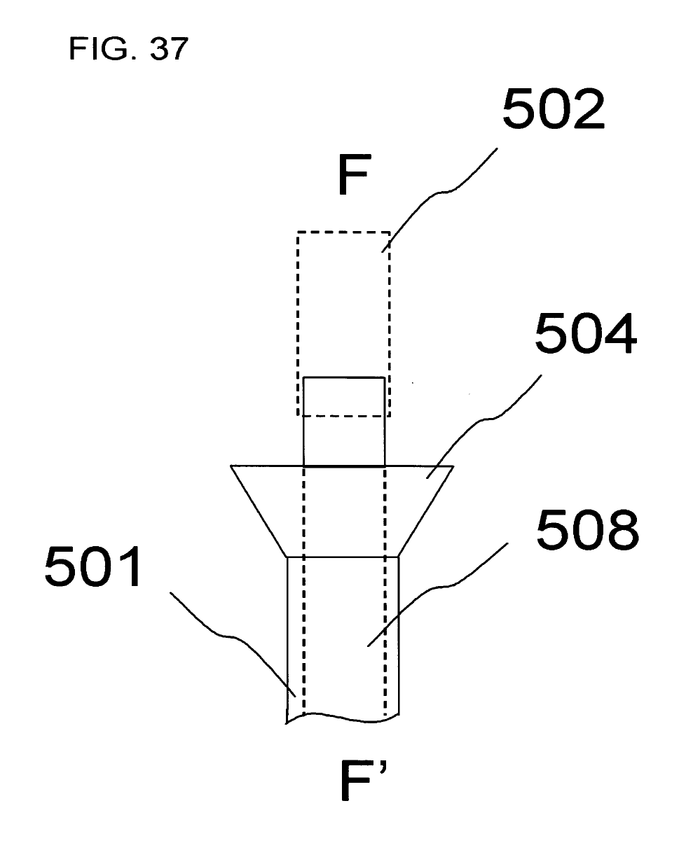

FIG. 36 is a view showing an example of configuration of a mobile terminal having a cleaning mechanism. Furthermore, FIG. 37 is a cross-sectional view showing the configuration in the vicinity of the end portion of a rod 501 of the mobile terminal shown in FIG. 36 taken along the line F-F′. The mobile terminal shown in FIG. 36 and FIG. 37 further incorporates a cleaning liquid cassette 507, a cleaning channel 505, and a control mechanism 506 in addition to a main body 500, in the mobile terminal shown in FIG. 34.

A cleaning channel 508 is provided in the rod 501. The cleaning channel 508 communicates to the cleaning liquid cassette 507 via the control mechanism 506. For example, cleaning liquid including diluted neutral detergent or hypochlorous acid and an expansive agent such as compressed carbon dioxide gas are accommodated in the cleaning liquid cassette 507. When the control mechanism 506 is pushed, the cleaning channel 505 opens and the cleaning liquid moves to the cleaning channel 505 and the cleaning channel 508 in the rod 501 in this order to automatically belch from the vicinity of the leading edge of the rod 501, resulting in cleaning the sensor unit 502.

Since a hood 504 which expands in diameter toward the sensor unit 502 is provided in the vicinity of the leading edge of the rod 501, dispersion of the cleaning liquid can be suppressed and the sensor unit 502 can be efficiently cleaned. Furthermore, the hood 504 is slidably provided along the extending direction of the rod 501, whereby it can be configured so as to cover the sensor unit 502 in cleaning. In doing so, the sensor unit 502 can be further efficiently cleaned. Material of the rod 501 and the hood 504 may be resin such as Teflon (registered trademark) with chemical drug tolerance. In doing so, deterioration of the rod 501 and the hood 504 can be suppressed and can be used for a long time.

The cleaning liquid cassette 507 can be a cartridge which is detachable to the main body 500. In doing so, when there is shortage of the cleaning liquid and expansive agent in the cleaning liquid cassette 507, a cleaning liquid cassette 507 is removed from the main body 500 and replaced with a new cleaning liquid cassette 507, and therefore the cleaning liquid and expansive agent can be supplemented.

As described above, the present invention is explained based on the embodiments. These embodiments are exemplifications and those skilled in the art will appreciate that there are various modifications and such modifications will be included in the scope of the present invention.

For example, in the above embodiments, the case using a mobile phone as the mobile terminal 127 applied to the measuring device 129 is described as an example, the mobile terminal 127 applied to the measuring device 129 is not limited to mobile phones, for example, portable computers or the like may be used.

Furthermore, the analysis center 153 can correct analysis result of each user 187 according to measurement location or a state regarding time, in which the user 187 has performed using the mobile terminal 127. For example, in an adrenal cortical hormone such as a blood cortisol and a pituitary hormone such as a growth hormone, there is high and low in measurement values according to time in a day and therefore this can be corrected according to measurement time. Furthermore, in the case where items in which measurement values fluctuate according to ambient temperature of the measurement values are measured, information on ambient temperature of measurement location is separately obtained and after the measurement values are corrected according to this, analysis can be performed. Furthermore, information stored in the analysis information memory unit 169 can be corrected and analyzed for each user 187 based on the past measurement result or analysis result for each user 187 stored in the user information memory unit 175.

Furthermore, in the above embodiments, the case where shape of the detection unit provided in the chip is mainly cylindrical is exemplified, it is not limited to cylindrical but it may be appropriately selected provided that these have shape so that analysis of contents (detection or measurement) are performed. For example, the shape of the detection unit can be a rectangular cylinder such as a quadrangular prism. Furthermore, it can be all right that the detection unit is not diverticulum shaped, for example, it may be channel shape as aforementioned with reference to FIG. 9.

Furthermore, in the above mention, other reservoir provided in the chip except the detection cell, for example, in the case of the chip shown in FIG. 3, the sample introducing unit 105 and the reservoir 107 may also be all right provided that volume sufficient for holding liquid which is introduced to each reservoir or recovered is secured, it may be shape other than cylinder. Shape of the reservoir provided in the chip may be, for example, a rectangular cylinder such as a quadrangular prism and channel shape of a predetermined plane shape. Furthermore, shape of a reservoir acted as a waste reservoir may be, for example, zig-zag shaped channel viewed from plane or columnar shape formed with concavity and convexity on the inner surface. In doing so, since surface area of the waste reservoir can be increased, capillary effect can be further improved and waste liquid can be further securely recoverable configuration.

Furthermore, in the above embodiments, the chip insertion portion 131 or the cutout portion 132 are formed in the mobile terminal 127, however, it may be formed that the chip 101 is not inserted in the chip insertion portion 131 or the cutout portion 132. As such measurement, for example, the following aspect of (I) or (II) can be formed.
(I) Noncontact Measurement

The chip 101 is not inserted in the chip insertion portion 131 or the cutout portion 132, but noncontact measurement can be performed. By the noncontact measurement, contamination due to a reagent adhered to the mobile terminal 127 can be certainly suppressed. Furthermore, degree of freedom of mode of measurable chip 101 can be enhanced and the mobile terminal 127 can be generally used.

As noncontact measurement, specifically, for example, scanning of a point-of-sale (POS) terminal type can be performed. In this case, a small POS scanning device is mounted on the mobile terminal 127. Laser pulse of a single-wavelength or several wavelengths is sequentially irradiated to a plurality of detection cells provided in the chip 101 by this scanning device. Measurement for each detection cell can be made by measuring intensity of reflection laser pulse at each detection cell in scanning.

Furthermore, intensity of reflection light can be measured by reflecting light at the chip 101. For example, a mirror surface can be provided at the bottom surface of the detection unit by the metal deposition method or the like. Further, the entire bottom surface of the chip 101 may be a mirror surface. Length of an optical path can be increased by providing the mirror surface, and therefore more accurate measurement value can be obtained.

Furthermore, a positioning target on bar-code can be provided at the chip 101. In doing so, in the case where measurement is performed about many detection cells, measurement value on which detection cell is measured can be readily determined by position relationship between the targets.
(II) Use of Measurement Attachment Connectable to Mobile Terminal

Measurement can be made without directly inserting the chip 101 to the chip insertion portion 131 or the cutout portion 132 by separately providing a measurement attachment connectable to the mobile terminal 127. Degree of freedom of mode of the chip 101 can be increased by measuring via an adapter. Furthermore, contamination of the mobile terminal 127 can be prevented. Further, structure of the mobile terminal 127 itself can be simplified. Further, degree of freedom of measurement method can be increased because kind of the attachment can be selected.

Specifically, a measurement attachment may be mounted on the mobile terminal 127 to perform measurement by means of a CCD camera. In this case, vicinity of the detection cell of the chip 101 is filmed via a fixture for fixing distance and position of the chip 101 and the camera. The fixture corresponding to the attachment can be reduced in size by making it collapsible.

When measuring, the chip 101 is provided at the bottom surface of the fixture and the mobile terminal 127 is placed at a predetermined position of the upper surface of the fixture to fix. At this time, the CCD camera provided on the mobile terminal 127 is placed so as to face downward. After filming by pushing the shutter button, intensity of coloring at each detection unit can be estimated from intensity of each RGB by image processing.

Furthermore, the measurement attachment used by connecting to the mobile terminal can be configured to be connected to the mobile terminal via, for example, USB, RS232C, GPIB interface such as parallel I/O, or the like. In doing so, contamination of the mobile terminal can be further certainly suppressed and the mobile terminal and the measurement attachment can be more certainly connected.

Furthermore, the chip 101 may have an electronic chip. The measuring device 129 and the inspection system 100 can further provide the following function by using the chip 101 having an electronic chip and the mobile terminal 127, for example,
(i) to be in noncontact;
(ii) use of person authentication;
(iii) use of position information;
(iv) use of chip ID itself;
(v) guarantee of expiration date of chip;
(vi) selection of custom IC specification from mobile terminal;
(vii) combination of mobile terminal and online ordering; and
(viii) function of outputting trigger for disabling reading of ID information after measuring.
These will be described in order below.
(i) To be in Noncontact

When the chip 101 having an electronic chip is used, noncontact measurement can be performed without inserting the chip 101 into the mobile terminal 127. Therefore, measurement can be made even if the chip insertion portion 131 or the cutout portion 132 is not formed in the mobile terminal 127.

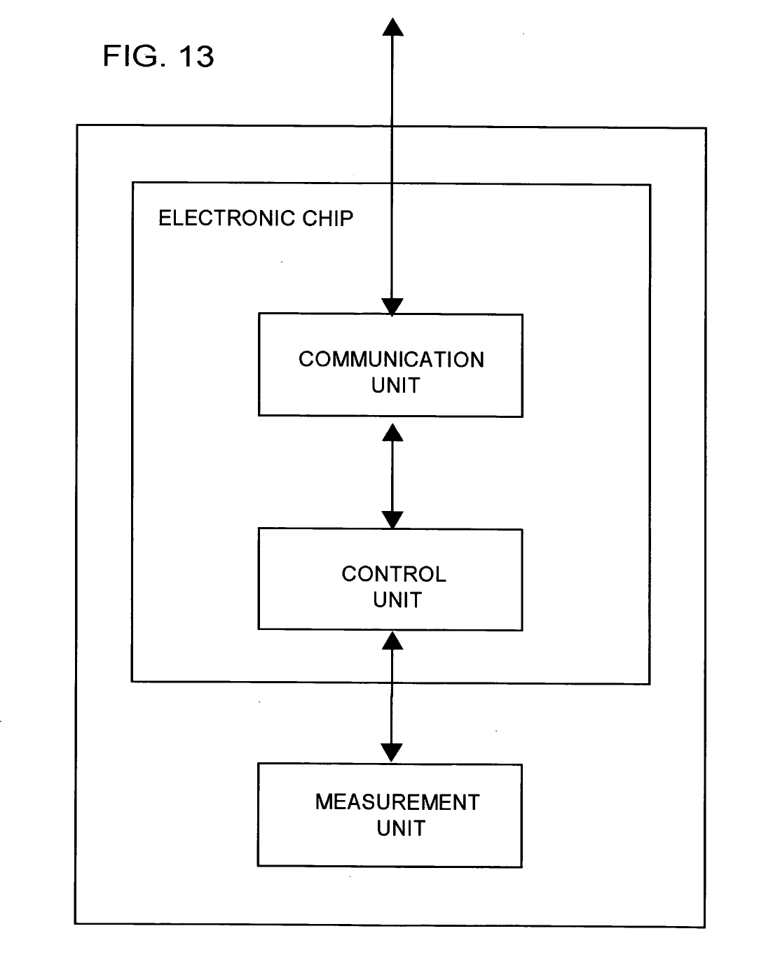

In this case, the chip 101 itself is configuration to have a measurement unit. FIG. 13 is a view showing configuration of such chip 101. In the chip of FIG. 13, transmitting/receiving of information with the mobile terminal 127 at a communication unit provided in the electronic chip can be performed. Furthermore, the electronic chip has a control unit which controls measurement conditions at the measurement unit based on information received at the communication unit. This configuration can transmit measurement data from the communication unit to the mobile terminal 127. Transmission can be, for example, radio signal. Furthermore, according to this configuration, device configuration of the mobile terminal 127 can be simplified and therefore the measuring device 129 can be further efficiently produced.
(ii) Use of Person Authentication

The chip 101 is configured to have an electronic chip, whereby a user of the chip 101 is limited to a specific person or use of measurement data can be limited to a specific person. Therefore, protection of privacy of a user of the chip 101 can be enhanced. For example, it may be configured so that other person cannot read data from a scrapped chip 101, the electronic chip is used as means for charging on line, or it can be configured that when a chip 101 is ordered on line, the chip 101 in which user's personal information is stored arrives to the user and only when information of the chip 101 conforms to the personal information held in the mobile terminal 127, it can be usable.
(iii) Use of Position Information

It is configured that the chip 101 having an electronic chip emits weak electric wave receivable at limited range, whereby it is possible to transmit position information of the chip 101 as information on position of the mobile terminal 127 even if the mobile terminal 127 has not function to transmit one's own position information.
(iv) Use of Chip ID Itself

When the chip 101 having an electronic chip is used, improper use of the chip 101 by a user can be prevented. For example, it can be configured that when a personal user orders a chip 101 for liver function test on line, the mobile terminal 127 records information on the order. In doing so, it can be configured that even when a chip 101 used for other than liver function test, for example, a chip 101 for renal function test arrives by mistake, measurement can not be performed in the case where information on kinds of the chip 101 recorded in the mobile terminal 127 is different from information on the ID of the chip 101, that is, which is the chip for renal function test or the like.
(v) Guarantee of Expiration Date of Chip

Guarantee of expiration date of chip 101, generally, is printed by character on the surface of the chip 101, but there is a case where it is not necessarily checked by a user. Consequently, an electronic chip can be used in order to prevent human error in confirming expiration date for use. For example, an electronic chip for a timer can be provided on the chip 101. Furthermore, it can be a type in which date of manufacture can be read by the mobile terminal 127, for example, it can be recorded by a bar-code, a magnetic tape, or the like.
(vi) Selection of Custom IC Specification from Mobile Terminal

By using the chip 101 having an electronic chip, a chip 101 designed for versatile type is provided, whereby it can be used by customizing according to placing order. For example, information on kinds of the chip 101 ordered on line, for example, a chip or the like for liver function measurement is recorded in the mobile terminal 127 and specification of the chip 101 is changed on the spot according to data on its kind, whereby it can be customized to a chip for liver function measurement in which specific items are measured.

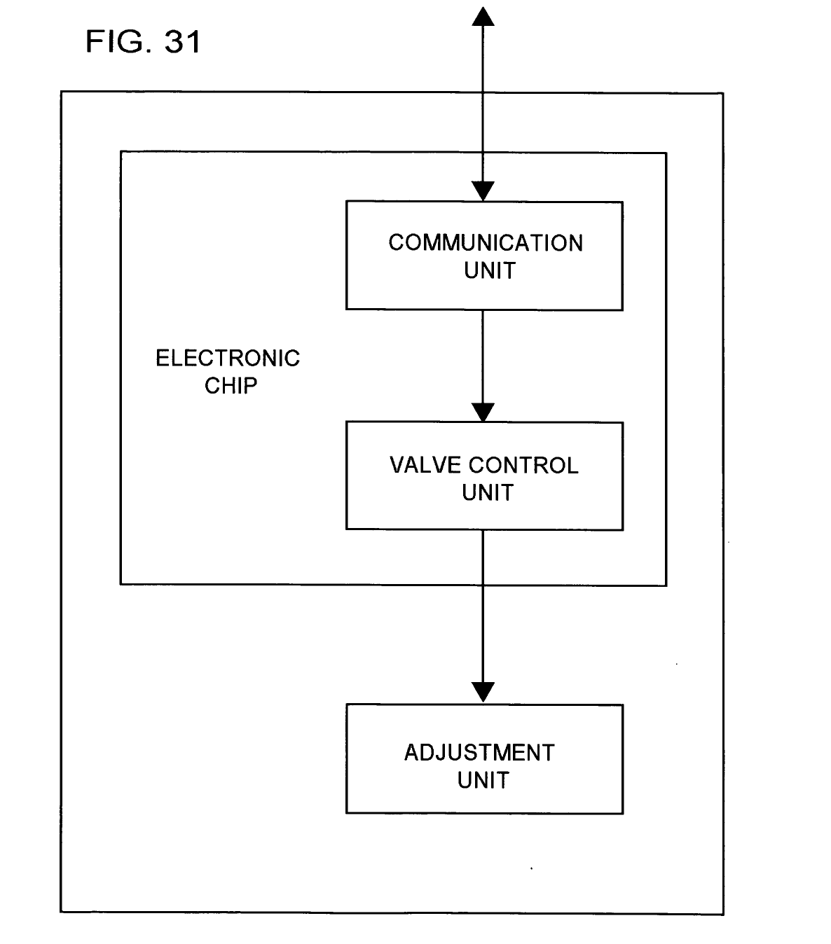

FIG. 31 is a view showing an example of configuration of such chip 101. A chip 101 of FIG. 31 has an electronic chip and an adjustment unit. The electronic chip has a communication unit which performs transmitting/receiving of information with the mobile terminal 127 and a valve control unit which controls a moving pathway of a sample introduced to the chip 101. In the chip 101, an adjustment unit capable adjusting moving or not of the sample is provided in the moving pathway of the sample. The adjustment unit can be, for example, a valve capable of opening/closing, provided in the channel. The valve control unit can perform control for opening/closing of the valve of the adjustment unit based on information received from the communication unit. In doing so, the moving pathway of the sample in the chip can be customized according to information on kinds of the sample, kinds of the chip, measurement objects, or the like.

Customizing process flow of the chip can be, for example, the following way. After placing an order on line, information on the kinds of the chip 101 is recorded in the mobile terminal 127. Then, information on the kinds of the chip 101 is converted to ON/OFF pattern data of the valve provided on the chip 101 at the mobile terminal 127 and when the pattern data is transmitted to the chip 101, the electronic chip provided on the chip 101 opens/closes the valve on the chip according to the pattern. In doing so, the customized chip is completed to be usable. Furthermore, according to information on the kinds of the chip 101, that is, information recorded in the mobile terminal 127 and information recorded in the chip 101, it may be configured that measurement data is sent/received between them.

In addition, as a design of the customizable chip 101, for example, an electrical valve device may be used. This valve device has configuration that current temporarily flows between electrodes and solution in a channel is electrodeposited to generate air bubbles. The generated air bubbles remain at the portion because the channel is narrow and consequently close the channel. The air bubbles once generated do not immediately disappear and therefore a predetermined channel can be irreversibly closed.
(vii) Combination of Mobile Terminal and Online Ordering

When a user directly performs online ordering using the chip 101 and the mobile terminal 127, order record can be stored in the mobile terminal 127. On the other hand, when ordering is performed from a fixed terminal, it is preferable to transmit the ordered information to the mobile terminal 127. It can be a system including processing that information on the ordering of the chip 101 is automatically transferred to the mobile terminal 127 side by embedding an electronic chip in the chip 101.
(viii) Function of Outputting Trigger for Disabling Reading of ID Information After Measuring

In the case where an electronic chip including a wireless tag is packaged in the chip 101 for use in the mobile terminal 127, when information including ID of a user or the chip 101 is scrapped, there is an unpreferable case from the standpoint of privacy information protection. In such case, it can be configured that the mobile terminal 127 generates “nullifying trigger” which determines timing for disabling reading of information on authentication data such as ID or the like in which the chip 101 holds as electronic information when scrapping the chip 101. The chip 101 is configured to generate the nullifying trigger when removing the chip from the mobile terminal 127, whereby risk in which a third person reads ID information can be reduced and the chip 101 can be safely scrapped. Therefore, privacy information can be further certainly protected.

For example, it may be configured that the chip having an electronic chip has a portion which records authentication data and the mobile terminal 127 has a mechanism in which removal of a chip 101 of post measurement from the mobile terminal 127 is a trigger for disabling a read of authentication data.

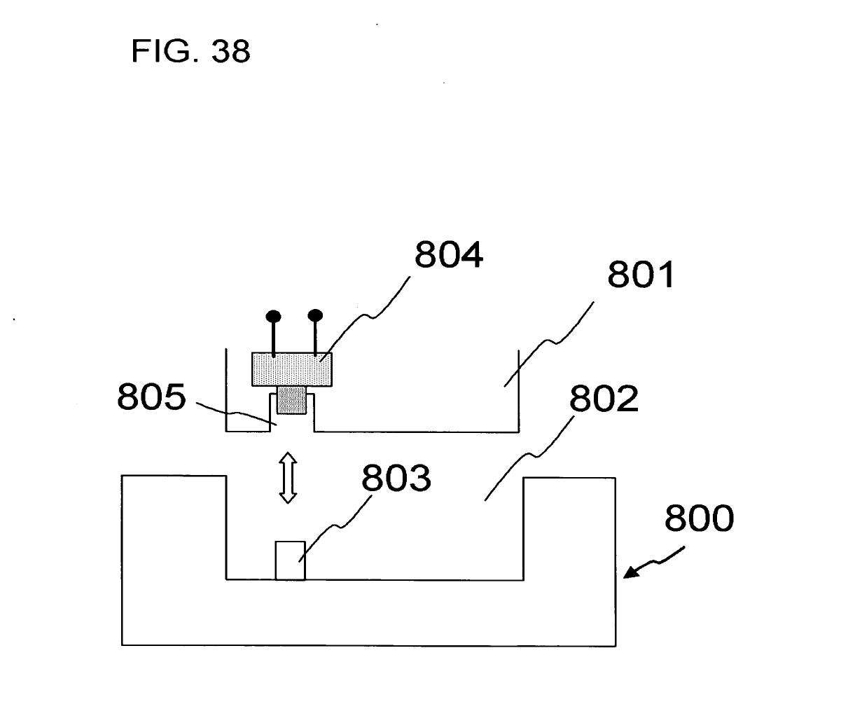

FIG. 38 is a view showing configuration of a mobile terminal 800 which generates nullifying trigger. Fundamental configuration of the mobile terminal 800 shown in FIG. 38 can be configuration of the mobile terminal 127 aforementioned in the first embodiment. Furthermore, the mobile terminal 800 shown in FIG. 38 includes a nullifying convex portion 803 provided in a concave shaped attachment unit 802 to which a chip 801 is attached. When the chip 801 is attached to the mobile terminal 800, the nullifying convex portion 803 is inserted into a nullifying concave portion 805 provided in the chip 801.

A switch 804 for opening/closing an electric circuit related to erasing of ID information is protruded in the nullifying concave portion 805, and when the nullifying convex portion 803 is inserted, the switch 804 is compressed toward the inside. Measurement is performed in a state where the switch 804 is compressed, and when the chip 801 is separated from the attachment unit 802 after measurement is completed, the nullifying convex portion 803 which compresses the switch 804 separates. This becomes nullifying trigger and consequently the electric circuit related to erasing of ID information opens or shielded and disables reading of ID information.

In a method for disabling reading by opening or shielding of the electric circuit, for example, there is a method to use a fuse. In this method, ID information packaged in the chip 801 is held, and a portion of the electric circuit provided for presenting it outside is disconnected by using a fuse so as not to act. It is configured that a fuse is provided in any conductive wire constituting the electric circuit in series, a power source for flowing overmuch current in the fuse to disconnect is provided, and the switch 804 is placed at the midd1e of the series circuit constituted by the power source and the fuse.

When the switch 804 becomes conductive, the power source and the fuse become conductive and the fuse is disconnected. The power source may be placed inside the chip 801 and it may be configured that it is placed in the mobile terminal to supply current to the chip 801 via electrodes. In the latter case, when the chip is completely separated from the mobile terminal, current can not be supplied and therefore electrodes for supplying current to the chip 801 are deformable electrodes, for example, spring type electrodes which maintain a state of contact while the chip 801 is completely come off from the nullifying convex portion 803.

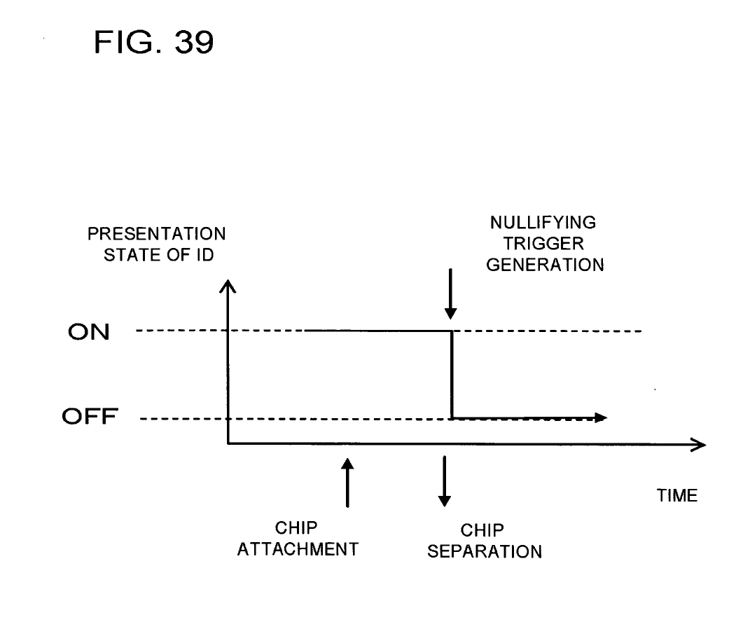

FIG. 39 is a view of a time chart showing timing in which a nullifying trigger generates at the mobile terminal 800 shown in FIG. 38. In FIG. 39, as the switch 804, a switch of a type in which electrical connection or discontinuation is generated when moving from a state compressed into inside the chip 801 to a state released to the nullifying concave portion 805 side is used.

Furthermore, it can be configured to be ineffective by keeping the chip away from the mobile terminal. For example, in the case where ID information is presented by radio transmission, the mobile terminal completes to receive radio-transmitted data from the chip and this sets off not to read ID information. To that end, it can be configured that the mobile terminal sends a nullifying signal to the measuring chip after completion of receiving measurement data from the chip and the chip nullifies the before-mentioned electric circuit when receiving the nullifying signal.

Nullification can be realized by that, for example, in the case where the chip has a logic circuit and receives the nullifying signal from the mobile terminal, excess current is flown from a power source in which the chip holds to a low capacity fuse provided on the above-mentioned electric circuit to disconnect, excess current is flown from an antenna of the chip to the above-mentioned electric circuit by radiating excess electric wave from the mobile terminal to disconnect the fuse, or the like.

Furthermore, in the above embodiments, it can be configured that the mobile terminal has a pocket capable of attachment/removal and replacement convenient for scrapping the chip. From the standpoint of environmental protection, there are many difficult cases where a chip is scrapped on the spot and therefore it can be considered that a used chip is taken out. In such case, it becomes possible to bring and carry a used chip in a state of integrally accommodated with a mobile terminal by using the mobile terminal having a chip accommodation unit for accommodating the used chip. Therefore, convenience in bringing and carrying can be improved.

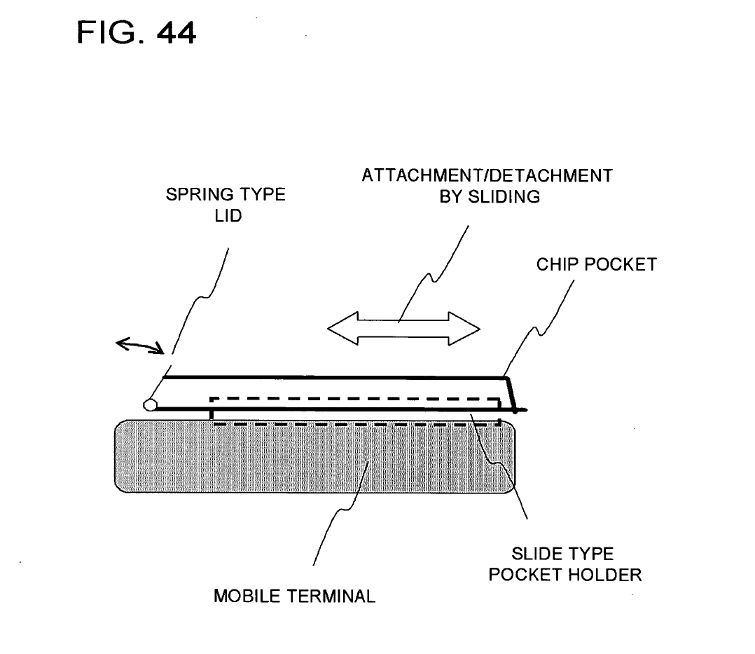

FIG. 44 is a view showing an example of configuration of a mobile terminal having a chip accommodation unit. FIG. 44 is a cross-sectional view showing configuration of the mobile terminal having a pocket accommodating a used chip as the chip accommodation unit. The mobile terminal shown in FIG. 44 includes a detachable chip pocket. Attachment/detachment of the chip pocket to/from the mobile terminal is performed by sliding the chip pocket along a slide type pocket holder provided in the mobile terminal. A spring type lid is provided in the chip pocket. When the spring type lid is opened and a used chip is accommodated in the chip pocket, the spring type lid closes and therefore the chip is held in the pocket.

Furthermore, in the above embodiments, a cover for preventing dust from entering when not used may be provided at the chip insertion portion of the mobile terminal having the measurement unit. For example, a lid for removing dust can be provided on the chip insertion portion 131 in FIG. 4 and the cutout portion 132 in FIG. 11. As the lid, for example, it can be configured that a slide type lid is provided and the lid is slided to expose the chip insertion portion 131 or the cutout portion 132 when measuring, then the chip is inserted. Furthermore, a spring type lid can be provided in place of a lid other than a slide type. Further, it can be configured that a plug-in type dummy chip for lid is inserted in the cutout portion of the mobile terminal.

Furthermore, in the above embodiments, a measurement instrument of electrical characteristics to the chip having electrodes may be provided in the mobile terminal. For example, in the case where electric resistance is measured as electrical characteristics, electrodes can be arranged on the surface of the chip and the attachment unit. In doing so, measurement on specific components in a sample can be performed using change in electrical characteristics. Therefore, kinds of measurable samples can be increased.

1. A measurement system comprising:
a measuring chip which includes a sample introducing unit and a detection unit communicated to said sample introducing unit, the chip applying a predetermined operation to a sample introduced into said sample introducing unit and introducing it to said detection unit; and
a mobile terminal which performs measurement on a specific component contained in said sample introduced to said measuring chip,
wherein said mobile terminal includes
an insertion portion in which said measuring chip is inserted,
a measurement unit which performs measurement on characteristics of said component introduced to said detection unit, and
a transmitting unit which transmits measurement result obtained by said measurement unit outside.

2. A measurement system comprising:
a measuring chip which includes a sample introducing unit and a detection unit communicated to said sample introducing unit, the chip applying a predetermined operation to a sample introduced to said sample introducing unit and introducing it to said detection unit; and
a mobile terminal which performs measurement on a specific component contained in said sample introduced to said measuring chip,
wherein said mobile terminal includes
a measurement unit which performs measurement on characteristics of said component introduced to said detection unit, and
a transmitting unit which transmits measurement result obtained by said measurement unit outside.

3. The measurement system as set forth in claim 1,
wherein said measurement unit includes a light source which irradiates light to said detection unit, and a light receiving unit which performs measurement on optical characteristics of said component using outgoing light from said light source.

4. The measurement system as set forth in claim 1,
wherein said measuring chip includes a channel which reaches said detection unit from said sample introducing unit, and a separating unit which separates said component is provided in said channel.

5. The measurement system as set forth in claim 1,
wherein said detection unit provides a detecting substance which acts on said component and changes optical characteristics thereof.

6. The measurement system as set forth in claim 1,
said transmitting unit transmits said measurement result correlating with a measurement state outside.

7. The measurement system as set forth in claim 1,
said mobile terminal has mobile phone function.

8. The measurement system as set forth in claim 1, further comprising an analysis center which is connected to said mobile terminal via a network and receives an information transmitted from said mobile terminal,
said analysis center includes a data acquisition unit which obtains said measurement result transmitted from said mobile terminal, and an analysis unit which analyzes said sample based on measurement result obtained by said data acquisition unit and obtains analysis result.

9. The measurement system as set forth in claim 8,
wherein said analysis center includes an analysis data memory unit which stores said measurement result or said analysis result obtained by said analysis unit, and a reference data memory unit which stores data in which said analysis unit references.

10. The measurement system as set forth in claim 8,
wherein said mobile terminal includes a receiving unit which receives said analysis result transmitted from said transmitting unit.

11. The measurement system as set forth in claim 1,
wherein said measuring chip further includes a neutralization reservoir, and
said mobile terminal and said measuring chip further have a mechanism in which a removal of said measuring chip of post measurement from said mobile terminal is a trigger for introduction of said neutralization liquid in said neutralization reservoir into a channel system included in said measuring chip.

12. The measurement system as set forth in claim 1,
wherein said measuring chip further includes a portion which records authentication data, and
said mobile terminal has a mechanism in which a removal of said measuring chip of post measurement from said mobile terminal or a completion of receiving data at said mobile terminal is a trigger for disabling of a read of said authentication data.
